(19) United States
(12) Patent Application Publication
(10) Pub. No.: US 2011/0262816 A1
(43) Pub. Date: Oct. 27, 2011

(54) POLYHYDROGEN FLUORIDE BASED BATTERY

(76) Inventor: Glenn Amatucci, Peapack, NJ (US)

(21) Appl. No.: 13/143,950

(22) PCT Filed: Jan. 12, 2010
(86) PCT No.: PCT/US2010/020814

§ 371 Date: Jul. 11, 2011

Related U.S. Application Data
(60) Provisional application No. 61/144,062, filed on Jan. 12, 2009.

(51) Int. Cl. H01M 10/056

(52) U.S. Cl. 429/336; 429/199; 429/339

(57) ABSTRACT

The described invention relates to primary and secondary electrochemical energy storage systems, particularly to such systems as battery cells, which use materials that take up and release ions as a means of storing and supplying electrical energy, and methods of fabrication thereof.

### CROSS REFERENCES

This application claims benefit of priority to U.S. application 61/144,062, filed Jan. 12, 2009, the content of which is incorporated by reference herein in its entirety.

### STATEMENT OF GOVERNMENT FUNDING

This invention was made with U.S. government support. The government has certain rights in the invention.

### FIELD OF THE INVENTION

The described invention relates to primary and secondary electrochemical energy storage systems, and primary and secondary electrochemical energy storage system as battery cells that use materials that take up and release ions as a means of storing and supplying electrical energy.

### BACKGROUND

Li-ion batteries are the current state of the art high energy density rechargeable electrochemical energy storage system. These batteries contain lithiated transition metal oxides as the positive electrode, a lithium conducting solution as the electrolyte, and a carbonaceous or alloy negative electrode material. During the discharge of such batteries, Li ions diffuse from the lithiated graphite negative electrode, through the lithium ion conducting electrolyte, and into the vacancies formed by the crystal structure of the transition metal oxide positive electrode. Parallel to this reaction, an electron is released from the LiₓC₆ negative electrode, which flows through an external circuit to perform work and into the positive electrode to reduce the transition metal. These reactions are summarized in Equation 1 and Equation 2 for the negative and positive electrodes, respectively:

Li₁C₆→Li₁₋ₓC₆+xLi⁺+xe⁻ [Equation 1]

xLi⁺+xe⁻+Li_{y}CoO₂→Li_{y+x}CoO₂ [Equation 2]

Unfortunately, the performance of the Li ion battery still falls short of energy density goals in applications ranging from telecommunication to biomedical. Although a number of factors within the battery cell contribute to energy density, the most crucial factors relate to how much energy can be stored in the positive and negative electrode materials of a given device. The positive electrode of Li-ion batteries is dominated by the layered Li intercalation compound, LiCoO₂ (Mizushima, K., et al. Mater. Res. Bull. 15:783. 1980). LiCoO₂ has a practical reversible specific capacity of 150 mAh/g. Alternate electrode materials include compounds and solid solutions containing LiNiO₂ (Thomas, M. G. S. R., et al. Mater. Res. Bull. 20:1137. 1985) or LiMn₂O₄ (Thackeray, M. M., et al., Mater. Res. Bull. 18:461. 1983; Tarascon, J. M., et al., J. Electrochem. Soc. 138:2859. 1991). These materials are lower in cost and the latter environmentally is more acceptable; however, the capacity of these materials does not exceed that of LiCoO₂ by a great extent (<200 mAh/g).

For the past decade there has been an extensive search for new electrode materials. Negative electrodes have been improved by the introduction of negative electrodes that alloy with lithium at low voltages. Such electrodes have capacity exceeding that of existing carbonaceous anodes by a factor of 2 to 7.

Numerous studies have focused on new positive electrode materials, particularly on layered manganese compounds of the general formula LiMnO₂ (Armstrong, A. R., and Bruce, P. G., Nature 381:499. 1996) and phosphate materials of the general formula LiMePO₄ (Padhi, A. K., et al., J. Electrochem. Soc. 144:1188. 1997) and Li₃Me₂(PO₄)₃ (Padhi, A. K., et al., J. Electrochem. Soc. 144:1609. 1997), where Me is a transition metal. Although operating at a lower voltage and close to the same capacity as LiCoO₂, these materials are of interest due to their low cost and safety. The positive electrode traditionally has been limited by the 1 electron (e) transfer per formula unit that plagues intercalation materials. The LiCoO₂ electrode only allows for a partial Co³⁺←→Co⁴⁺ reduction-oxidation (redox) reaction (see Equation 1). However, the fundamental route to attaining the highest specific capacity of an electrode remains the utilization of all of the possible oxidation states of a compound during the redox cycle. This can be done by way of a reversible conversion reaction which proceeds according to the formula: nLi++ne−+Men⁺X←→nLiX+Me (see Equation 2).

Studies have shown that such reversible conversion reactions only are active for low potential materials suitable for use as negative electrodes, such as oxide and sulfide chalcogenides (Poizot, P., et al., Nature. 407:496. 2000) and the transition metal nitrides (Pereira, L. C., et al., J. Electrochem. Soc. 148:A262. 2002).

Accordingly, an increase in the specific capacity of the positive electrode would require the adoption of reversible conversion to positive electrode materials and would require at least a 1V increase in output voltage with respect to the previously demonstrated chalcogenide and nitride materials. The output voltage of primary conversion reactions is rooted in basic thermodynamics and is well understood. It generally is believed that an increase in the Me—X bond ionicity will result in an increase in the output voltage associated with reaction (1). Therefore the output voltage of (1) would be expected to increase through the highly covalent metal nitrides and sulfides, to the metal oxides, through the inductive effect polyanions (e.g., metal phosphates, metal borates), finally to the highly ionic metal fluoride and metal chloride halogens.

Metal fluorides, however, largely have been ignored as reversible positive electrodes for rechargeable lithium batteries due to their insulative nature brought about by their characteristic large bandgap. Studies have reported that iron trifluoride (FeF₃) has limited electrochemical activity, with a reported capacity of 80 mAh/g in a discharge voltage region from about 4.5V to 2V, which involved the Fe³⁺ to Fe²⁺ redox transition (Arai, H., et al., J. Pow. Sources, 68:716. 1997). This poor electronic conductivity, combined with a questionable ionic conductivity, results in the disparity between the observed reversible specific capacity (80 mAh/g) and the theoretical (1 e⁻ transfer) capacity (237 mAh/g).

Additional studies have reported use of nanostructured metal fluoride active materials in a conductive matrix (Badway, F., et al., J. Electrochem. Soc., 150: A1318. 2003). Nanosized crystals have a large portion of total material volume on their surfaces that contain numerous defects, which substantially can contribute to enhanced electronic and ionic activity (Maier, J., Solid State Ionics. 148:367. 2002). Studies have reported that these materials have increased capacity of two-fold to five-fold over that of current positive electrode materials (Amatucci, G. G., and Pereira, N., J. Fluor. Chem. 128(4):243-262. 2007). Further, the grains of each of these materials have been connected electronically through the use of highly conducting carbon. Additional studies have reported that FeF₃ carbon metal fluoride nanocomposites (CMFNCs) offer excellent reversible specific capacity through a second reaction occurring at 2V where the combined specific capacities result in an exceptional total capacity of approximately 600 mAh/g. It was reported that this metal fluoride reaction was due to a reversible fluoride-based conversion reaction. Additional transition metal based fluorides such as, but not limited to, NiF₂, CoF₂, FeF₂, BiF₃, SbF₃, and PbF₂, have been studied; all showed exceptional ability to store large amounts of electrical energy per weight or volume. Further, it has been reported that the electrically conducting carbon matrix has been replaced with that of an electrically conducting oxide matrix allowing dense composites with little interfacial surface area with the electrolyte (Badway, F., et al., Chem. Mater. 19:4129. 2007).

Fluorides of higher voltage and specific capacity, such as CuF₂ and CFₓ, have been studied during efforts to increase energy densities beyond those that already have been demonstrated. CFₓ materials have high specific capacity and voltage exceeding the theoretical gravimetric energy densities of most metal fluoride materials. CFₓ materials have been utilized for many years as positive electrode materials in lithium batteries. However, the electrode reaction has not been shown to be reversible, and the reaction occurs at voltages that are significantly below voltages of theory (T. Nakajima (Ed.), “Fluorine Carbon and Fluoride Carbon Materials”, Marcel Dekker, NY (1995) ISBN 0-8247-9286-6; Amatucci, G. G., and Pereira, N., J. Fluor. Chem. 128 (4):243-262, 2007).

Although fast fluoride conductors are known, beyond thin film, the application of these conductors to a practical energy storage chemistry is very difficult, since (1) most are of very large heavy polyvalent cations (LaF₃), the weight of which will negate any specific energy benefit received; (2) the interface with the electrodes is very difficult to control due to the high modulus of the ceramic powder; and (3) the materials are expensive. Of these, the weight of the electrolyte is the fundamental limit to progression. The described invention provides a class of materials which meet all the above mentioned requirements. These materials are based on the bifluoride anion (F—H—F)⁻ and its polyhydrogen fluoride derivatives (HF)ₙF⁻ with various cations. As used herein, the term “bifluoride” encompasses the polyhydrogen fluoride derivatives (HF)ₙF⁻ where n is from >0 to 10, unless otherwise specified. It generally is believed that the bifluoride anion never has been utilized in a battery application. The bifluoride anion of the described compounds and compositions facilitates fluoride transfer during the cycling process. Coupled with a cation containing an organic component, these materials offer excellent conductivity, excellent interface conformity due to their low modulus, and are exceptionally lightweight. The ideal properties of fluoride based electrolytes include: low molecular weight; high ionic conductivity; low modulus (to conform to electrode interfaces); and high intrinsic (or via passivation) anodic and cathodic stability at the negative and positive electrodes, respectively. The described invention further provides electrochemical energy storage cells, and methods of synthesis thereof, comprising the inventive electrolytes coupled to positive electrodes comprising nanostructured metal fluorides, carbon fluorides, various metals and carbon materials combined with negative electrode materials of alkali, or alkaline earth, zinc, aluminum, silicon and germanium metals.

### SUMMARY

According to one aspect, the described invention provides an electrolyte for an electrochemical battery cell, the electrolyte comprising at least one bifluoride anion. According to one embodiment, the bifluoride anion is of the formula (F(HF)ₙ⁻), where n is from >0 to 10. According to another embodiment, the bifluoride anion is of the formula ((F(HF)ₙ⁻), wherein n=1. According to another embodiment, the bifluoride anion is of the formula ((F(HF)ₙ⁻), wherein n=2. According to another embodiment, the bifluoride anion is of the formula (F(HF)ₙ⁻), wherein n=3. According to another embodiment, the electrolyte comprises a plurality of bifluoride anions. According to another embodiment, the electrolyte comprises at least one cation comprising at least one organic group. According to another embodiment, the at least one cation comprising at least one organic compound is a tetraalkyl ammonium, and wherein the alkyl is an alkyl of 1 to 10 carbon atoms. According to another embodiment, the electrolyte is a tetralkylammonium (HF)ₙF⁻ wherein n is from >0 to 10. According to another embodiment, the electrolyte is tetraethyl ammonium (HF)ₙF⁻ wherein n is from >0 to 10. According to another embodiment, the electrolyte is tetrapropyl ammonium (HF)ₙF⁻ where n is from >0 to 10. According to another embodiment, the electrolyte is tetramethyl ammonium (HF)ₙF⁻ where n is from >0 to 10. According to another embodiment, the electrolyte comprises a plurality of (HF)ₙF⁻ containing salts, wherein n is from >0 to 10. According to another embodiment, the electrolyte comprises pyridinium (HF)ₙF⁻ where n is from >0 to 10. According to another embodiment, the electrolyte comprises tetramethyl ammonium (HF)ₙF⁻ where n is from >0 to 10. According to another embodiment, the electrolyte comprises potassium (HF)ₙF⁻ where n is from >0 to 10. According to another embodiment, the electrolyte comprises calcium (HF)ₙF⁻ where n is from >0 to 10. According to another embodiment, the electrolyte comprises an ionic liquid comprising (HF)ₙF⁻ where n is from >0 to 10. According to another embodiment, the electrolyte comprises an onium (HF)ₙF⁻ where n is from >0 to 10. According to another embodiment, the electrolyte further comprises 1,3-dialkylimidazolium fluorogydrogenate (HF)ₙF⁻ where n is from >0 to 10. According to another embodiment, the electrolyte is a catholyte.

According to another aspect, the described invention provides a fluoride anion conducting material comprising (i) a positive electrode; (ii) a negative electrode; and (iii) an electrolyte comprising a fluoride anion of the formula (HF)ₙF⁻ wherein n is >0 to 10; whereby the material conducts F− anions. According to one embodiment, the positive electrode comprises at least one metal or at least one carbon, wherein the at least one metal or at least one carbon is in an electrochemically reduced state; and the negative electrode comprises at least one metal fluoride. According to another embodiment, the positive electrode comprises at least one carbon selected from the group consisting of graphite, a single walled carbon nanotube, and a multiwalled carbon nanotube. According to another embodiment, the positive electrode comprises at least one metal selected from the group consisting of Bi, Cu, Mo, Fe, Ag, Au, Pd, Ni, Co, Mn and V. According to another embodiment, the negative electrode comprises an alkali fluoride. According to another embodiment, the negative electrode comprises an alkaline earth fluoride. According to another embodiment, the negative electrode comprises an element selected from the group consisting of Zn, Al, Si, and Ge. According to another embodiment, the positive electrode comprises at least one metal fluoride or at least one carbon fluoride, wherein the at least one metal fluoride or at least one carbon fluoride is in an electrochemically oxidized state; and the negative electrode comprises at least one metal. According to another embodiment, the positive electrode comprises a graphite fluoride. According to another embodiment, the positive electrode comprises at least one compound selected from the group consisting of bismuth fluoride, silver fluoride, nickel fluoride, copper fluoride, lead fluoride, cobalt fluoride, molybdenum fluoride and iron fluoride. According to another embodiment, the positive electrode further comprises at least one electronically conductive material. According to another embodiment, the positive electrode is an electrode where a predominant diffusing species is a fluoride ion. According to another embodiment, the positive electrode comprises a nanostructure carbon selected from the group consisting of a nanographite, a carbon nanotube, a buckyball, a mesoporous carbon, and a microporous carbon. According to another embodiment, the negative electrode accepts a fluoride ion. According to another embodiment, the negative electrode comprises lanthanum. According to another embodiment, the negative electrode comprises lithium. According to another embodiment, the negative electrode comprises sodium. According to another embodiment, the negative electrode comprises calcium. According to another embodiment, the negative electrode comprises strontium. According to another embodiment, the negative electrode comprises barium. According to another embodiment, the negative electrode comprises rubidium. According to another embodiment, the negative electrode comprises potassium. According to another embodiment, the electrolyte comprises at least one bifluoride anion. According to another embodiment, the at least one bifluoride anion is of the formula (F(HF)ₙ⁻), wherein n is from >0 to 10. According to another embodiment, the at least one bifluoride anion is of the formula (F(HF)ₙ⁻), wherein n=1. According to another embodiment, the e at least one bifluoride anion is of the formula (F(HF)ₙ⁻), wherein n=2. According to another embodiment, the at least one bifluoride anion is of the formula (F(HF)ₙ⁻), wherein n=3. According to another embodiment, the electrolyte comprises a plurality of bifluoride anions. According to another embodiment, the electrolyte comprises at least one cation comprising at least one organic group. According to another embodiment, the at least one cation comprising at least one organic group is a tetralkylammonium bifluoride, wherein the alkyl is an alkyl from 1 to 10 carbons. According to another embodiment, the electrolyte is a tetraalkyl ammonium (HF)ₙF⁻, wherein n is from >0 to 10, and wherein the alkyl is an alkyl of 1 to 10 carbon atoms. According to another embodiment, the electrolyte is tetraethyl ammonium (HF)ₙF⁻ wherein n is from >0 to 10. According to another embodiment, the electrolyte is tetrapropyl ammonium (HF)ₙF⁻ wherein n is from >0 to 10. According to another embodiment, the electrolyte is tetramethyl ammonium (HF)ₙF⁻ wherein n is from >0 to 10. According to another embodiment, the electrolyte comprises a plurality of (HF)ₙF⁻ containing organic groups, wherein n is from >0 to 10. According to another embodiment, the electrolyte further comprises diphenylguanidium (HF)ₙF⁻ wherein n is from >0 to 10. According to another embodiment, the electrolyte further comprises 1,3-dialkylimidazolium fluorogydrogenate (HF)ₙF⁻ wherein n is from >0 to 10. According to another embodiment, the electrolyte is substantially free of HF.

According to another aspect, the described invention provides a rechargeable electrochemical battery cell comprising: (i) a negative electrode comprising a metal fluoride; (ii) an electrolyte comprising (HF)ₙF− where n is from >0 to 10; (iii) an optional additional electrolyte; and (iv) a positive electrode comprising a compound of a low oxidation state, wherein a predominant diffusing species is a fluoride ion. According to one embodiment, the negative electrode comprises at least one element selected from the group consisting of lanthanum, lithium, sodium, calcium, strontium, barium, potassium, and rubidium. According to another embodiment, the positive electrode comprises an element selected from the group consisting of carbon, silver, gold, copper, bismuth, nickel, cobalt, molyndenum, manganese, vanadium and palladium. According to another embodiment, the positive electrode comprises at least one nanostructured carbon selected from the group consisting of a nanographite, a carbon nanotube, a buckyball, a mesoporous carbon and a microporous carbon. According to another embodiment, the positive electrode is a partially oxidized positive electrode. According to another embodiment, the partially oxidized positive electrode comprises at least one compound selected from the group consisting of BiF₃, bismuth oxyfluoride, CuF₂, MnF₂, NiF₂, CoF₂, CFₓ where x<1, AgF, a first row transition metal oxide, and a silver oxide. According to another embodiment, the electrolyte is a solid state fluoride conductor. According to another embodiment, the electrolyte comprises at least one bifluoride anion. According to another embodiment, the at least one bifluoride anion is of the formula (F(HF)ₙ⁻), wherein n is from >0 to 10. According to another embodiment, the at least one bifluoride anion is of the formula (F(HF)ₙ⁻), wherein n=1. According to another embodiment, the at least one bifluoride anion is of the formula (F(HF)ₙ⁻), wherein n=2. According to another embodiment, the at least one bifluoride anion is of the formula (F(HF)ₙ⁻), wherein n=3. According to another embodiment, the electrolyte comprises a plurality of bifluoride anions. According to another embodiment, the electrolyte comprises at least cation comprising at least one organic group. According to another embodiment, the at least one cation comprising at least one organic group is a tetralkylammonium bifluoride, wherein the alkyl is an alkyl from 1 to 10 carbons. According to another embodiment, the electrolyte is a tetraalkylammonium (HF)ₙF⁻ wherein n is from >0 to 10, and wherein the alkyl is an alkyl of 1 to 10 carbon atoms. According to another embodiment, the electrolyte is tetraethyl ammonium (HF)ₙF⁻ wherein n is from >0 to 10. According to another embodiment, the electrolyte is tetrapropyl ammonium (HF)ₙF⁻ wherein n is from >0 to 10. According to another embodiment, the electrolyte is tetramethyl ammonium (HF)ₙF⁻ wherein n is from >0 to 10. According to another embodiment, the electrolyte comprises a plurality of (HF)ₙF⁻ containing organic groups, wherein n is from >0 to 10. According to another embodiment, the electrolyte further comprises diphenylguanidium (HF)ₙF⁻ wherein n is from >0 to 10. According to another embodiment, the electrolyte further comprises 1,3-dialkylimidazolium fluorogydrogenate (HF)ₙF⁻ wherein n is from >0 to 10. According to another embodiment, the electrolyte is substantially free of HF. According to another embodiment, the electrochemical battery cell operates at a voltage greater than or equal to 4V.

### BRIEF DESCRIPTION OF THE DRAWINGS

FIG. 1 shows nonlimiting illustrative schematics of the operation of the described inventive cells utilizing negative electrode anode based on lanthanum (La or LaF3), an electrolyte/catholyte based on tetraethyl ammonium polyhydrogen fluoride and a positive electrode of carbon or carbon fluoride.

FIG. 2 shows a nonlimiting embodiment of the described rechargeable electrochemical battery cell of FIG. 1A wherein the hydrogen produced may be fed into a fuel cell that is either discreet or integrated into the electrochemical battery cell.

FIG. 3 shows X-ray diffraction patterns of (1) the original tetraethylammonium fluoride hydrate and (2) the resulting product after annealing under vacuum at 143° C.

FIG. 4 shows plots of absorbance (Abs) versus wavenumbers (cm⁻¹) from FTIR of the original tetraethylammonium fluoride hydrate, the resulting product after annealing under vacuum at 143° C., and bifluoride standards NaHF₂ and NH₄HF₂.

FIG. 5 shows an illustrative schematic design of a 2 electrode test cell.

FIG. 6 shows a plot of output voltage versus time (hours) for Li/TEAF/CF1000 and Li/LiPF₆EC DMC/CF1000 electrochemical battery cells at 70° C. and 0.00025 mA.

FIG. 7 shows a plot of voltage versus time (hours) of a fabricated electrochemical battery cell utilizing CF_{0.8} cathode material, a TEAF electrolyte, and a lithium anode.

FIG. 8 shows a plot of voltage versus time (hours) of a fabricated electrochemical battery cell utilizing a BiF₃ composite cathode as the positive electrode, a TEAF electrolyte, and a Li anode.

FIG. 9 shows a plot of the X-ray diffraction pattern of a partially discharged cathode from the cell of FIG. 8.

FIG. 10 shows a plot of the voltages recorded from the fabricated electrochemical battery cell and the individual potentials of Li versus the silver quasi reference (−3.5V), CF_{1.1} versus the silver quasi reference (approximately −0.2V), and the output voltage (the difference between the reference potentials).

FIG. 11 shows a plot of voltages recorded from the fabricated electrochemical battery cell and the individual potentials of Pb versus the silver quasi reference, CF_{1.1} versus the silver quasi reference, and the output voltage.

FIG. 12 shows FTIR spectra (absorbance versus wavenumbers (cm⁻¹)) of the fabricated electrolytes teaf06, teaf09, teaf15, teaf21, teaf27 and teaf30.

FIG. 13 shows X-ray diffraction patterns of the fabricated electrolytes teaf06, teaf09, teaf15, teaf21, teaf27 and teaf30.

FIG. 14 shows a plot of log conductivity (S/cm) versus HF (ml) utilized in the initial fabrication of the TEAF electrolyte.

FIG. 15 shows FTIR spectra of the resulting crystalline materials produced by differing ratios of hydrated tetraethylammonium and tetramethylammonium fluoride.

FIG. 16 shows a plot of log conductivity (S/cm) versus x in TExMAF (temaf electrolyte samples fabricated with differing ratios of hydrated tetraethylammonium fluoride and tetramethylammonium fluoride).

FIG. 17 shows a plot of cell output voltage versus time (hours) of a Li/te100maf/CF_{1.1} electrochemical battery cell.

FIG. 18 shows a plot of voltages recorded from a fabricated 3 electrode Li/te100maf/CF_{1.1} electrochemical battery cell and the individual potentials of the Li negative electrode versus the silver quasi reference, CFₓ positive electrode versus the silver quasi reference, and the cell output voltage.

FIG. 19A shows an illustrative schematic of the electrochemical reaction within the fabricated electrochemical battery cell utilizing a LaF₃ negative and Ag positive electrode along with a bifluoride containing electrolyte; FIG. 19B shows a plot of voltage versus time (seconds).

FIG. 20A shows an illustrative schematic of the electrochemical reaction within the fabricated electrochemical battery cell utilizing a LaF3 negative and Au positive electrode along with a bifluoride containing electrolyte; FIG. 20B shows a plot of voltage versus time (seconds).

FIG. 21 shows a plot of voltage versus time (seconds) of a cell consisting of a LaF₃ negative electrode, a multiwalled carbon nanotube positive electrode and a bifluoride containing electrolyte.

### DETAILED DESCRIPTION

### Glossary

The term “alkyl” as used herein refers to a straight or branched chain hydrocarbon having from 1 to 100 carbon atoms, optionally substituted with substituents.

The term “anion” as used herein refers to a negatively charged ion.

The term “anode” as used herein refers to an electrode where oxidation occurs and electrons flow from the anode to the cathode via an external circuit during the discharge of the cell. During charge the electronic current flow is reversed

The term “battery” as used herein refers to a power source that produces direct current (DC) by converting chemical energy into electrical energy. These power sources employ spontaneous electrochemical reactions as the source of the electrical energy by allowing the electrons to flow from a reductant (anode) to the oxidant (cathode) externally, through the conductor. Each single battery cell contains a negative electrode (anode) that contains a reducing material in which an oxidation process takes place upon discharge, a positive electrode (cathode) containing an oxidizing material in which an oxidation process takes place upon discharge, and an electrolyte system (liquid, gel, or solid). Primary batteries are not designed to be recharged. Secondary batteries are designed for repetitive use, and thus can be charged and discharged periodically. The term “practical battery” refers to a battery that has been designed or adapted for actual use, or is in actual operation.

The term “buckyball” as used herein refers to a carbon based molecule of buckminsterfullerene.

The term “capacitance” (“C”) as used herein refers to a measure of the capability of a capacitor to store electrical charge at a potential difference ΔU (voltage) between the two plates of the device.

The term “capacity” (of batteries) as used herein refers to the total amount of charge stored in a cell or a battery, which can be withdrawn under specified discharge conditions. Capacity commonly is expressed in ampere-hours. “Practical (actual) capacity” refers to the amount of electricity (charge), usually expressed in Ah, that can be withdrawn from a battery at specific charge conditions. Contrary to theoretical capacity and theoretical capacity of a practical battery, the practical capacity of a battery is a measured quantity, and intrinsically incorporates all the losses to the theoretical capacity due to the mass of the nonactive components of the cell, and the electrochemical and chemical limitations of the electrochemical system. The practical capacity of a cell is dependent on the measurement conditions, such as, for example, temperature, cut-off voltage, and discharge rate. The phrase “theoretical capacity of a practical battery” refers to the calculated maximum amount of charge (in Ah kg⁻¹) (referred to as specific capacity) that can be withdrawn from a practical battery based on its theoretical capacity, and the minimum necessary nonactive components such as, electrolyte, separator, current-collectors, and container. The term “theoretical capacity” refers to the calculated amount of electricity (charge) involved in a specific electrochemical reaction (expressed for battery discharge), and usually expressed in terms of ampere-hours per kg or coulombs per kg. The theoretical capacity for mole of electrons amounts to 96,487 C or 26.8 Ah. The general expression for the calculation of the theoretical capacity (in Ah kg⁻¹) for a given anode material and cathode material and their combination as full cell is given by C^{th}ₛ=nF/M, [Formula 1] in which n is the moles of electrons involved in the electrochemical reaction, M is the molecular weight of the electroactive materials, and F stands for the Faraday constant. In calculating the theoretical capacity for a battery, only the cathode and anode material masses are taken into consideration, ignoring the electrolyte, separator, current collectors, container, and the like.

The term “cathode” as used herein refers to a positive electrode where reduction occurs and electrons flow from anode to the cathode during the discharge of the electrochemical cell.

The term “catholyte” as used herein refers to an electrolyte solution which also acts as a cathode (i.e., supports a redox reaction and is the primary ion conducting medium).

The term “cation” as used herein refers to a positively charged ion.

In electrochemistry, the term “charge” is used for the electric charge (physical quantity) with positive or negative integer multiples of the elementary electric charge, e. The sum of charges always is conserved within the time and space domains in which charge is transported. The term “charge” also frequently is used to refer to “positive charge” and “negative charge” just to indicate the sign of it.

The phrase “charge capacity of a battery” refers to the amount of electrical charge that is stored in a battery material and/or in an entire battery electrode. Charge capacity is measured in coulombs. Practically, charge is usually expressed in Ah (ampere hour). 1 Ah is 3600 coulombs. Hence, the charge capacity of one mol of electroactive material that undergoes one electron transfer per process is 1 F or 26.8 Ah. For the practical world of energy storage and conversion, highly important is the specific charge (specific capacity), which is expressed in Ah per 1 gram (Ah g⁻¹) for gravimetric specific capacity or in Ah per liter (Ah L⁻¹) for volumetric capacity. It is important to distinguish between theoretical and practical specific capacity. “Theoretical specific charge capacity” is based on the molecular weight of the active material and the number of electron transfers in the electrochemical process. “Practical specific charge capacity” is the actual capacity that can be obtained in the process and it depends on many practical factors, such as the kinetic limitations of the electrochemical process, temperature of operation, cutoff voltage, electrodes design and configuration, and the like. In the fields of capacitors and rechargeable batteries, “charge capacity” defines the capacity that is involved in the charge process of the device, and is usually compared to the capacity that is involved in the discharge process (“discharge capacity”). The losses in the charge process should be minimal in order to obtain good cycleability life of the device.

The term “combination electrode” as used herein refers to a combination of an ion-selective electrode and an external reference electrode in a single unit, thus avoiding a separate holder for the external reference electrode, i.e., it usually contains one ion-selective membrane and two reference electrodes, one on either side of the membrane.

The term “composite” as used herein refers to a compound comprising at least one or more distinct components, constituents, or elements.

The term “conduction” as used herein refers to the flow of electrical charge through a medium without the medium itself moving as a whole.

The term “conductive matrix” as used herein refers to a matrix that includes conductive materials, some of which may be ionic and/or electronic conductors. Materials in which the matrix retains both ionic and electronic conductivity commonly are referred to as “mixed conductors.”

The term “conductivity” (“electrical conductivity”, “specific conductance”) as used herein refers to the ease with which an electric current can flow through a body. Conductivity may be expressed as siemens per meter.

The term “conductor” (“electric conductor”) as used herein refers to a medium which allows electric current to flow easily. Such a medium may be, for example, a metal wire, a dissolved electrolyte, or an ionized gas, among others.

As used herein, the term “crystal” refers to a homogenous solid formed by a repeating, three-dimensional pattern of atoms, ions, or molecules and having fixed distances between constituent parts or the unit cell of such a pattern. As used herein, the term “crystal structure” refers to the arrangement or formation of atoms or ions within the crystal.

The term “current” as used herein refers to the movement of electrical charges (i) in a conductor; (ii) carried by electrons in an electronic conductor (“electronic current”) or (iii) carried by ions in an ionic conductor (“ionic current”).

The term “cut-off voltage” as used herein refers to the end-point for battery charge or discharge, defined by its voltage. “Discharge cut-off voltage” is defined both to protect cells from overdischarge, and to set regulation for characterization of a battery's performance, based on intended application. “Charging cut-off voltage” is defined to protect a cell's overcharge and damage. Cut-off voltage also is referred to as “cutoff voltage” or “end-voltage.”

The term “cycle-life” as used herein refers to the number of charge-discharge cycles through which a recycleable battery can go, at specified conditions, before it reaches predefined minimum performance limits. The cycle-life of any particular rechargeable battery is highly dependent on charge and discharge rates, charge and discharge cut-off limits, depth of discharge (DOD), self discharge rate, and service temperatures.

The term “depth of discharge” (DOD) as used herein refers to the percentage of the rated capacity that is drawn off during each discharge step. DOD is expressed in percentage (%) from the rated maximum capacity of the battery. The depth of discharge is one of the dominant parameters that determine the cycle life of a rechargeable battery. Generally, if a long cycle life is desired, the battery should be operated at low DOD or low rates.

The term “discharge rate” as used herein refers to the pace at which current is extracted from a battery. The discharge rate is expressed in amperes, amperes per gram, or in C rate, which is expressed as a multiple of the rated capacity in ampere-hours. For example, when a 2 Ah battery is discharged at C rate (C rate means coulombic rate), the total capacity will be delivered within 1 hour at 2 A. When discharging at 0.5 C rate, 2 hours will be required for completely discharging the battery at 1 A. When a battery is delivering energy it is said to be delivering energy by a discharging process (“discharging”). Theoretically, the discharging ends when all the active materials are consumed (“discharged”). However, practically, the discharge process stops way before the end point of the chemical reaction, at the cut-off voltage of the battery. Battery discharge curves, usually voltage versus time at constant discharge current or power, are important properties of batteries. The term “partially” discharged as used herein refers to a state of being less than about 100% discharged, less than about 90% discharged, less than about 80% discharged, less than about 70% discharged, less than about 60% discharged, less than about 50% discharged, less than about 40% discharged, less than about 30% discharged, less than about 20% discharged, less than about 10% discharged, less than about 5% discharged, or less than about 1% discharged.

The term “electrolyte” as used herein refers to a compound that dissociates into ions upon dissolution in solvents or/and upon melting, and which provides ionic conductivity. Compounds that possess a rather high ionic conductivity in the solid state are called “solid electrolytes.” “True electrolytes” are those that are build up of ions in the solid state (or pure form), whereas “potential electrolytes” are those that form ions only upon dissolution and dissociation in solvents (i.e., they exist as more or less covalent compounds in pure state).

The term “element” as used herein refers to simple substances which cannot be resolved into simpler substances by normal chemical means.

The phrase “limit of detection” (LOD) as used herein refers to the lowest concentration of an analyte that can be observed by an analytical method with a chosen statistical probability. LOD is derived from the smallest response that can be detected with reasonable certainty and the sensitivity of the method.

The term “matrix” as used herein refers to a material in which other material is embedded.

The terms “micrometer” or “micron range” are used interchangeably herein to refer to a dimension ranging from about 1 micrometer (10⁻⁶ m) to about 1000 micrometers.

The term “microporous” as used herein refers to being composed of or having pores or channels with diameters of less than 1.2 nm. The term “mesoporous” as used herein refers to being composed of or having pores or channels with diameters greater than 1.2 nm.

The terms “nanometer” or “nano range” are used interchangeably to refer to a dimension ranging from about 1 nanometer (10⁻⁹ m) to about 1000 nanometers.

As used herein, the terms “nanocrystallite” and “nanoparticle” are used interchangeably to refer to crystallites of less than an approximately 100 nm. As is well known in the art, crystallite size may be determined by common methodologies such as peak breadth analysis in X-ray diffraction (XRD) and high resolution transmission electron microscopy (HRTEM).

The term “nonrechargeable battery” (“primary battery cell”) as used herein refers to a single use battery. These batteries cannot be recharged.

The term “oxidant” as used herein refers to a substance that oxidizes another substance by accepting electrons from that substance to establish a lower energetic state. The oxidant itself is reduced during this reaction. Hence, oxidants are electron acceptors in redox reactions. A measure of the oxidation power is the redox potential.

The term “oxidation” as used herein refers to a reaction in which a substance (molecule, atom or ion) loses electrons. These are transferred to another substance (oxidant). The oxidation number of the substance being oxidized increases. Oxidation and reduction always occur simultaneously. In electrochemistry, oxidation processes proceed at anodes.

The term “oxidation-reduction potential” (redox potential) refers a measure of the oxidation/reduction capability of a solution (liquid or solid) measured with an inert electrode.

The term “predominant” and its various grammatical forms means most common, or prevalent.

The term “redox state” means the oxidation state of a compound or element. In electrochemistry this term is also used to characterize the ratio of the oxidized to the reduced form of one redox species when both forms are present in a solution or solid compound.

The term “reductant” as used herein refers to a substance (reducing agent) that reduces another substance by donating electrons to that substance to establish a lower energetic state. The reductant itself is oxidized during this reaction. Hence, reductants are electron donators in redox reactions. A measure of the reduction power is the redox potential.

The term “reduction” refers to a reaction in which a substance gains electrons from another reagent (reductant), which itself is oxidized. The oxidation number of the substance being reduced decreases. Reduction always occurs simultaneously with oxidation.

The term “self-discharge” refers to a spontaneous decrease in the amount of charge stored in a cell or battery.

The term “standard electrode potential” (“E^{o}”, “E⁰”) is the measure of individual potential of a reversible electrode at standard state, which for solutes is at an effective concencentration of 1 mol dm⁻³, and for gases is as a pressure of 1 bar. A pressure of 1 bar equals 10⁵ Pa. These values often are tabulated at 25° C.

The term “solid electrolyte” refers to a class of solid materials where the predominant charge carriers are ions. Solid electrolytes with mono-, bi- and trivalent ion charge carriers are known, and include, but are not limited to, silver (Ag⁺) cation conductors, copper (Cu⁺) conducting electrolytes, lithium (Li⁺) cation conductors, sodium cation (Na⁺) conductors, potassium (K⁺) cation conductors; rubidium (Rb⁺) conductors, thallium (Tl⁺) conducting electrolytes, cesium (Cs⁺) cation conductors, oxygen (O²⁻) anion conductors, fluoride (F⁻) anion conductors, and proton conductors.

Generally, the term “solid-state” electrochemistry refers to the branch of electrochemistry that includes the charge transport processes in solid electrolytes.

The term “specific capacity” as used herein refers to the amount of energy contained in milliamp hours (mAh) per unit weight. As used herein, the term “reversible specific capacity” means that a compound of the present invention may be recharged by passing a current through it in a direction opposite to that of discharge.

The phrase “state of charge” as used herein refers to the amount of charge stored in a battery, at a certain point of charging or discharging (or idle), expressed as the percentage of the rated capacity.

The terms “substantially free” or “essentially free” are used to refer to a material, which is at least 80% free from components that normally accompany or interact with it as found in its naturally occurring environment.

The term “TEAF” (teaf) as used herein, unless otherwise specified, means tetraethyl ammonium polyhydrogen fluoride Et₄N(HF)ₙF.

The term “TMAF” as used herein, unless otherwise specified, means tetramethyl ammonium polyhydrogen fluoride Me₄N(HF)ₙF.

The term “voltage” refers to the measure of the difference in electric potential between two chosen points of space.

The term “watt” (“W”) refers to a unit of power. 1 W=1 J s⁻¹=1 V A.

The described invention addresses many of the challenges of a high energy density rechargeable electrochemical energy storage system by replacing the lithium ion system with a fluoride ion systems utilizing polyhydrogen fluoride anions (HF)ₙF.

Table 1 shows an illustrative, non-limiting comparison of the lithium ion system and the fluoride ion system of the described invention. This example providing a lithium negative electrode is put forth so as to provide those of ordinary skill in the art with a complete disclosure and description of how to make and use the present invention, and is not intended to limit the scope of what the inventors regard as their invention nor is it intended to represent that the experiment below is all or the only experiment performed. The described invention is not limited to this chemical selection. During the discharge process of the described invention, instead of diffusing the lithium cations from the negative electrode to the positive electrode to form the reduction reaction (3), fluoride anions are removed from the positive electrode diffused through the electrolyte and reacted with the negative electrode to result in the same net reduction reaction (4).

TABLE 1

| | (3) Lithium Battery | (4) Fluoride Battery |
|---|---|---|
| Negative | Li → nLi⁺ + ne− | Li + nF⁻ → nLiF + ne⁻ |
| Electrode | | |
| Positive | Meⁿ⁺Fₙ + nLi⁺ + | Meⁿ⁺Fₙ + ne⁻ → Me + nF⁻ |
| Electrode | ne⁻ → Me + nLiF | |
| Net | Meⁿ⁺Fₙ + Li → Me + nLiF | Meⁿ⁺Fₙ + Li → Me + nLiF |

### 1. Electrolytes

According to one aspect, the described invention provides an electrolyte for an electrochemical battery cell, the electrolyte comprising at least one bifluoride anion. According to one embodiment, the at least one bifluoride anion is of the formula (F(HF)ₙ⁻), wherein n is from >0 to 10. According to another embodiment, the bifluoride anion is of the formula (F(HF)ₙ⁻), wherein n=1 or n>1. According to another embodiment, the bifluoride anion is (HF₂)⁻. According to another embodiment, the bifluoride anion is (HF)₂F⁻. According to another embodiment, the bifluoride anion is (HF)₃F⁻. According to another embodiment, the electrolyte comprises a plurality of bifluoride anions. According to another embodiment, the electrolyte comprises at least one of HF₂⁻, (HF₂)F⁻ and (HF)₃F⁻, or a combination thereof. According to another embodiment, the electrolyte comprises at least one bifluoride anion and at least one cation containing at least one organic group. According to some such embodiments, the at least one bifluoride anion is (HF)ₙF⁻ where n is from >0 to 10. According to some such embodiments, the at least one bifluoride anion is (HF)ₙF⁻ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride anion is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

According to some embodiments, the electrolyte is a tetralkylammonium (HF)ₙF⁻ where n is from >0 to 10, and the alkyl is an alkyl from 1 to 10 carbon atoms. According to some embodiments, the electrolyte is a tetralkylammonium (HF)ₙF⁻ where n is from >0 to 10, and the alkyl is an alkyl of 1 carbon atom. According to some such embodiments, the electrolyte is a tetralkylammonium (HF)ₙF⁻ where n is from >0 to 10, and the alkyl is an alkyl of 2 carbon atoms. According to some such embodiments, the electrolyte is a tetralkylammonium (HF)ₙF⁻ where n is from >0 to 10, and the alkyl is an alkyl of 3 carbon atoms. According to some such embodiments, the electrolyte is a tetralkylammonium (HF)ₙF⁻ where n is from >0 to 10, and the alkyl is an alkyl of 4 carbon atoms. According to some such embodiments, the electrolyte is a tetralkylammonium (HF)ₙF⁻ where n is from >0 to 10, and the alkyl is an alkyl of 5 carbon atoms. According to some such embodiments, the electrolyte is a tetralkylammonium (HF)ₙF⁻ where n is from >0 to 10, and the alkyl is an alkyl of 6 carbon atoms. According to some such embodiments, the electrolyte is a tetralkylammonium (HF)ₙF⁻ where n is from >0 to 10, and the alkyl is an alkyl of 7 carbon atoms. According to some such embodiments, the electrolyte is a tetralkylammonium (HF)ₙF⁻ where n is from >0 to 10, and the alkyl is an alkyl of 8 carbon atoms. According to some such embodiments, the electrolyte is a tetralkylammonium (HF)ₙF⁻ where n is from >0 to 10, and the alkyl is an alkyl of 9 carbon atoms. According to some such embodiments, the electrolyte is a tetralkylammonium (HF)ₙF⁻ where n is from >0 to 10, and the alkyl is an alkyl of 10 carbon atoms. According to some such embodiments, the electrolyte is a tetraalkylammonium (HF)ₙF⁻ where n=1, and the alkyl is an alkyl of 1 to 10 carbon atoms. According to some such embodiments, the electrolyte is a tetraalkylammonium (HF)ₙF⁻ where n=2, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=4, and the alkyl is an alkyl of 1 to 10 carbon atoms. According to some such embodiments, the electrolyte is a tetraalkylammonium (HF)ₙF⁻ where n=5, and the alkyl is an alkyl of 1 to 10 carbon atoms. According to some such embodiments, the electrolyte is a tetraalkylammonium (HF)ₙF⁻ where n=6, and the alkyl is an alkyl of 1 to 10 carbon atoms. According to some such embodiments, the electrolyte is a tetraalkylammonium (HF)ₙF⁻ where n=7, and the alkyl is an alkyl of 1 to 10 carbon atoms. According to some such embodiments, the electrolyte is a tetraalkylammonium (HF)ₙF⁻ where n=8, and the alkyl is an alkyl of 1 to 10 carbon atoms. According to some such embodiments, the electrolyte is a tetraalkylammonium (HF)ₙF⁻ where n=9, and the alkyl is an alkyl of 1 to 10 carbon atoms. According to some such embodiments, the electrolyte is a tetraalkylammonium (HF)ₙF⁻ where n=10, and the alkyl is an alkyl of 1 to 10 carbon atoms.

According to some such embodiments, the electrolyte is tetraethyl ammonium (HF)ₙF⁻ (TEAF), where n is from >0 to 10. According to some such embodiments, the electrolyte is tetrapropyl ammonium (HF)ₙF⁻ where n is from >0 to 10. According to some such embodiments, the electrolyte is tetramethyl ammonium (HF)ₙF⁻ where n is from >0 to 10. According to another embodiment, the electrolyte comprises a plurality of (HF)ₙF⁻ containing organic groups, where n is from >0 to 10.

According to another embodiment, the electrolyte further comprises diphenylguanidium (HF)ₙF⁻ where n is from >0 to 10.

According to another embodiment, the electrolyte further comprises 1,3-dialkylimidazolium fluorogydrogenate ((HF)ₙF⁻) where n is from >0 to 10.

According to another embodiment, the electrolyte comprises at least one bifluoride anion and at least one inorganic cation. According to some such embodiments, the at least one bifluoride anion is (HF)ₙF₋ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

According to another embodiment, the electrolyte is a catholyte.

### 2. Fluoride Anion Conducting Compositions

According to another aspect, the described invention provides a fluoride anion conducting material comprising (i) a positive electrode; (ii) a negative electrode; and (iii) an electrolyte; whereby the composition conducts F− anions.

According to one embodiment, the positive electrode is an electrode where the predominant diffusing species is a fluoride ion. According to another embodiment, the positive electrode comprises carbon. According to another embodiment, the positive electrode comprises at least one carbon (HF)ₙF⁻ where n is from >0 to 10. According to another embodiment, the positive electrode comprises silver. According to another embodiment, the positive electrode comprises at least one silver (HF)ₙF⁻ where n is from >0 to 10. According to another embodiment, the positive electrode comprises gold. According to another embodiment, the positive electrode comprises at least one gold (HF)ₙF⁻ where n is from >0 to 10. According to another embodiment, the positive electrode comprises copper. According to another embodiment, the positive electrode comprises at least one copper (HF)ₙF⁻ where n is from >0 to 10. According to another embodiment, the positive electrode comprises bismuth. According to another embodiment, the positive electrode comprises at least on bismuth (HF)ₙF⁻ where n is from >0 to 10. According to another embodiment, the positive electrode comprises palladium. According to another embodiment, the positive electrode comprises at least one palladium (HF)ₙF⁻ where n is from >0 to 10. According to another embodiment, the positive electrode comprises nanographite. According to another embodiment, the positive electrode comprises carbon nanotubes. According to another embodiment, the positive electrode comprises buckyballs. According to another embodiment, the positive electrode comprises mesoporous carbons. According to another embodiment, the positive electrode comprises microporous carbons.

According to another embodiment, the negative electrode is an electrode capable of accepting a fluoride ion. According to another embodiment, the negative electrode comprises lanthanum. According to another embodiment, the negative electrode comprises lithium. According to another embodiment, the negative electrode comprises sodium. According to another embodiment, the negative electrode comprises calcium. According to another embodiment, the negative electrode comprises magnesium. According to another embodiment, the negative electrode comprises strontium. According to another embodiment, the negative electrode comprises barium. According to another embodiment, the negative electrode comprises potassium. According to another embodiment, the negative electrode comprises rubidium. According to another embodiment, the negative electrode comprises zinc. According to another embodiment, the negative electrode comprises aluminum. According to another embodiment, the negative electrode comprises silicon. According to another embodiment, the negative electrode comprises germanium.

According to another embodiment, the electrolyte comprises at least one bifluoride anion. According to another embodiment, the bifluoride anion is of the formula (F(HF)ₙ⁻), wherein n is from >0 to 10. According to another embodiment, the bifluoride anion is of the formula (F(HF)ₙ⁻), wherein n=1 or n>1. According to another embodiment, the bifluoride anion is HF₂⁻. According to another embodiment, the bifluoride anion is (HF₂)F⁻. According to another embodiment, the bifluoride anion is (HF)₃F⁻. According to another embodiment, the electrolyte comprises a plurality of bifluoride anions. According to another embodiment, the electrolyte comprises at least one of HF₂⁻, (HF₂)F⁻ and (HF)³F⁻, or a combination thereof.

According to another embodiment, the electrolyte comprises at least one bifluoride anion and at least one cation containing at least one organic compound. According to some such embodiments, the at least one bifluoride anion is of the formula (HF)ₙF⁻ wherein n is from >0 to 10. According to some such embodiments, the at least one bifluoride anion is (HF)ₙF⁻ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride anion is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

According to some such embodiments, electrolyte is a tetralkylammonium (HF)ₙF⁻ where n is from >0 to 10, and the alkyl is an alkyl from 1 to 10 carbon atoms. According to some embodiments, the electrolyte is a tetralkylammonium (HF)ₙF⁻ where n is from >0 to 10, and the alkyl is an alkyl of 1 carbon atom. According to some such embodiments, the electrolyte is a tetralkylammonium (HF)ₙF⁻ where n is from >0 to 10, and the alkyl is an alkyl of 2 carbon atoms. According to some such embodiments, the electrolyte is a tetralkylammonium (HF)ₙF⁻ where n is from >0 to 10, and the alkyl is an alkyl of 3 carbon atoms. According to some such embodiments, the electrolyte is a tetralkylammonium (HF)ₙF⁻ where n is from >0 to 10, and the alkyl is an alkyl of 4 carbon atoms. According to some such embodiments, the electrolyte is a tetralkylammonium (HF)ₙF⁻ where n is from >0 to 10, and the alkyl is an alkyl of 5 carbon atoms. According to some such embodiments, the electrolyte is a tetralkylammonium (HF)ₙF⁻ where n is from >0 to 10, and the alkyl is an alkyl of 6 carbon atoms. According to some such embodiments, the electrolyte is a tetralkylammonium (HF)ₙF⁻ where n is from >0 to 10, and the alkyl is an alkyl of 7 carbon atoms. According to some such embodiments, the electrolyte is a tetralkylammonium (HF)ₙF⁻ where n is from >0 to 10, and the alkyl is an alkyl of 8 carbon atoms. According to some such embodiments, the electrolyte is a tetralkylammonium (HF)ₙF⁻ where n is from >0 to 10, and the alkyl is an alkyl of 9 carbon atoms. According to some such embodiments, the electrolyte is a tetralkylammonium (HF)ₙF⁻ where n is from >0 to 10, and the alkyl is an alkyl of 10 carbon atoms. According to some such embodiments, the electrolyte is a tetraalkylammonium (HF)ₙF⁻ where n=1, and the alkyl is an alkyl of 1 to 10 carbon atoms. According to some such embodiments, the electrolyte is a tetraalkylammonium (HF)ₙF⁻ where n=2, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=4, and the alkyl is an alkyl of 1 to 10 carbon atoms. According to some such embodiments, the electrolyte is a tetraalkylammonium (HF)ₙF⁻ where n=5, and the alkyl is an alkyl of 1 to 10 carbon atoms. According to some such embodiments, the electrolyte is a tetraalkylammonium (HF)ₙF⁻ where n=6, and the alkyl is an alkyl of 1 to 10 carbon atoms. According to some such embodiments, the electrolyte is a tetraalkylammonium (HF)ₙF⁻ where n=7, and the alkyl is an alkyl of 1 to 10 carbon atoms. According to some such embodiments, the electrolyte is a tetraalkylammonium (HF)ₙF⁻ where n=8, and the alkyl is an alkyl of 1 to 10 carbon atoms. According to some such embodiments, the electrolyte is a tetraalkylammonium (HF)ₙF⁻ where n=9, and the alkyl is an alkyl of 1 to 10 carbon atoms. According to some such embodiments, the electrolyte is a tetraalkylammonium (HF)ₙF⁻ where n=10, and the alkyl is an alkyl of 1 to 10 carbon atoms.

According to some such embodiments, the electrolyte is tetraethyl ammonium (HF)ₙF⁻ (TEAF), where n is from >0 to 10. According to some such embodiments, the electrolyte is tetrapropyl ammonium (HF)ₙF⁻ where n is from >0 to 10. According to some such embodiments, the electrolyte is tetramethyl ammonium (HF)ₙF⁻ where n is from >0 to 10. According to another embodiment, the electrolyte comprises a plurality of (HF)ₙF⁻ containing organics, where n is from >0 to 10.

According to another embodiment, the electrolyte further comprises diphenylguanidium (HF)ₙF⁻ where n is from >0 to 10.

According to another embodiment, the electrolyte further comprises 1,3-dialkylimidazolium fluorogydrogenate ((HF)ₙF⁻) where n is from >0 to 10.

According to another embodiment, the electrolyte comprises at least one bifluoride anion and at least one inorganic cation. According to some such embodiments, the bifluoride anion is of the formula (HF)ₙF⁻ wherein n is from >0 to 10. According to some such embodiments, the at least one bifluoride anion is (HF)ₙF₋ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride anion is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

### 3. Electrochemical Battery Cells

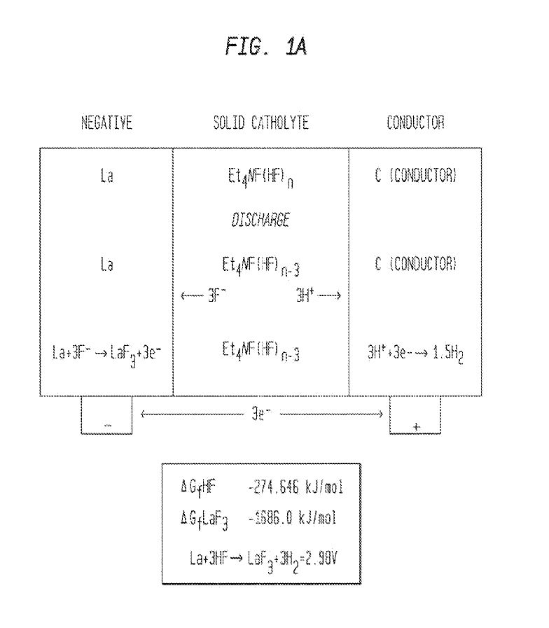

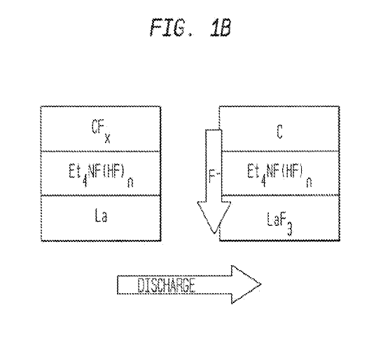

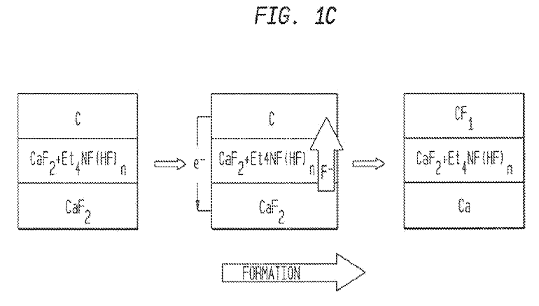

The described polyhydrogen fluorides have the ability to store HF molecules in a way that is relatively safe and non-corrosive by binding as polyhydrogen fluoride molecules (i.e., F(HF)ₙ), where n is from >0 to 10. The described invention relates to the use of an (HF)ₙF⁻, where n is from >0 to 10, containing molecule in various novel electrochemical cells. FIGS. 1A, 1B and 1C show nonlimiting, illustrative embodiments of the described invention.

FIG. 1A shows a nonlimiting illustrative schematic of the operation of another embodiment of the inventive cell utilizing the conductive electrodes La and tetra ethyl ammonium (HF)ₙF⁻. The reaction at the conductive or catalytic cathode, such as, for example, graphite, is 3HF→1.5H₂+3F⁻. The fluoride ion will conduct through the fluoride ion conducting polyhydrogen fluoride to induce the formation of a fluoride at the anode. The anode is a metal that forms a fluoride conductive material, such as, but not limited to, LaF₃, KF or CaF₂. For example, the reaction La+3e−→3LaF₃, with an overall cell reaction La+2H→LaF₃+1.5H₂ yields a theoretical voltage of 2.98V. The energy density is highly dependent on the solid catholyte that is chosen; a conservative material would be based on tetraalkylammonium salts.

Accordingly, cathode energy densities based on 2.98V for various catholytes at various obtainable HF contents are shown below in Tables 1-4.

TABLE 1

| | | | | | mAh/ | |
|---|---|---|---|---|---|---|
| Catholyte | g/mol | g/cc | mAh/g | Wh/kg | cc | Wh/L |
| NH₄F(HF)ₙ₌₂ | 77.049 | | 696 | 2073 | | |
| NH₄F(HF)ₙ₌₄ | 117.06 | 1.395 | 916 | 2730 | 3808 | 11348 |
| (CH₃)₄NF(HF)ₙ₌₄ | 177.197 | | 604.98 | 1803 | | |
| (C₂H₅)₄(NF(HF)ₙ₌₂ | 193.289 | | 277.3 | 826 | | |
| EMIF(HF)_{n=2.3} | 176.18 | | 350 | 1043 | | |
| KF(HF)ₙ₌₃ | 118.114 | 2.067 | 680.69 | 2029 | 1407 | 4193 |

TABLE 2

| Anode | g/mol | g/cc | mAh/g | mAh/cc |
|---|---|---|---|---|
| La(LaF₃) | 138.906 | 6.146 | 579 (509) | 3556 (3003) |
| | (157.904) | (5.900) | | |
| Ca(CaF₂) | 40.078 (78.074) | 1.55 (3.18) | 1337 (687) | 2072 (2185) |
| K(KF) | 39.098 (58.096) | 0.856 (2.48) | 686 (461) | 587 (1143) |
| Li(LiF) | 6.941 (25.939) | 0.535 (2.64) | 3861 (1033) | 2065 (2727) |

TABLE 3

| | | total cc | | |
|---|---|---|---|---|
| Couple | cc/mol | 3e− | mAh/cc | Wh/L |
| Ca/KF(HF)ₙ₌₃ | 40.1/118.1 | 95.93 | 838 | 2749 |
| | | | | (3.2 V) |
| La/KF(HF)ₙ₌₃ | 138.9/118.1 | 79.74 | 1008 | 3004 |
| | | | | (2.98 V) |

TABLE 4

| Couple | g/mol | total g 3e− | mAh/g | Wh/kg |
|---|---|---|---|---|
| Ca/KF(HF)ₙ₌₃ | 40.1/118.1 | 178.25 | 451 | 1443 |
| | | | | (3.2 V) |
| La/KF(HF)ₙ₌₃ | 138.9/118.1 | 257 | 313 | 933 |
| | | | | (2.98 V) |

Tables 1-4 show that the energy density of the couples exceed that of the state of the art Li-ion battery by over a factor of 5 (200 Wh/kg vs. 1443 Wh/kg and 400 Wh/L vs. 3000 Wh/L).

FIG. 1B shows a nonlimiting illustrative schematic of the operation of another embodiment of the inventive cell utilizing a negative electrode of La, an electrolyte of tetraethyl ammonium (HF)ₙF⁻, and a cathode comprising a metal fluoride or carbon fluoride. During discharge, the F⁻ anion diffuses from the positive electrode to the negative electrode and oxidizes the anode to LaF₃. The reaction can be reversed to reform the initial starting species at both electrodes. The presence of the bifluoride anion may catalyze the reversible nature of the reaction especially in the case of carbon fluorides as it is known in chemical studies that HF may spontaneously incorporate itself within the crystal structure of the carbon fluoride and aid the reversible insertion and deinsertion of the F− anion. FIG. 1C shows a nonlimiting illustrative schematic of the operation of another embodiment of the inventive cell where the cell is fabricated in the discharged state. The negative electrode comprises an alkali or alkaline earth fluoride, the electrolyte comprises a polyhydrogen fluoride anion (HF)ₙF⁻, and the cathode comprises a metal that maintains a high redox potential (>−1V versus SHE) and may be used as a positive electrode. The positive electrode also may be graphitic, a nanotube or a C60-like carbon. During the charge, the F⁻ anion will be extracted from the negative electrode, diffuse through the (HF)F⁻ containing electrolyte, and then fluorinate the cathode. This will allow the formation of highly reactive positive electrode materials that cannot normally be handled in air, in situ. In addition, the presence of the (HF)ₙF⁻ containing electrolyte will assist the formation of carbon fluorides as the (HF)F⁻ group is readily accessible to the intercalation space present between the basal planes of the graphite. The cells then can be discharged effectively reversing the aforementioned process and allowing power to be delivered to the external circuit.

Such electrochemical battery cells may be rechargeable.

The described invention further provides cells having high voltage potential. The output voltage of an electrochemical battery cell is established by the potential difference between the positive and negative electrodes. As with other nonaqueous and solid state batteries, the fluoride battery benefits greatly from the ability to accept negative electrode materials of extremely negative redox potentials (>2V) below that of the standard hydrogen potential (SHE) and >2V above the SHE. High voltage potential of >4V of such batteries have not been previously demonstrated; the main reason is that electrodes at the extreme potentials (especially those strongly positive of SHE) cannot be handled with ease and have not been able to be established into cells. The described invention further provides a cell that is fabricated in its discharged or partially discharge state and then charged to form high voltage electrodes. Further, this cell utilizes a polyhydrogen fluoride containing electrolyte.

The described invention provides a numerous advantages.

For example, regarding the negative electrode, normally high voltage cells need to be assembled with highly reducing alkali or alkaline earth negative electrode materials. These materials include, for example, but are not limited to, those of calcium, lanthanum, potassium, and lithium. These materials are extremely sensitive to water and oxygen vapor and also are expensive to have produced in metallic form. In the described invention, such negative electrodes are fabricated in their oxidized state. For example, fluorides of lanthanum, calcium, and potassium can all be utilized in pure or compounded state. Upon the first charge these electrodes will reduce forming the valuable and highly electrochemical active state in situ.

Additionally, regarding the positive electrode, while fluoride batteries have been shown to operate with lead fluoride and bismuth fluoride electrodes, such electrodes only give potentials <1V above SHE electrode and full battery voltages in the 2-3V range. Such electrodes are introduced as fluorinated electrodes. There are higher voltage fluorinated electrodes known, but handling such electrodes (AgF₂, AgF₃, AuF₃, CoF₃) are either difficult or dangerous due to their high reactivity. The described invention provides use of positive electrodes which are introduced in the reduced state and the ability to form such electrodes in situ (Ag→AgF₃; Au→AuF₃; C→CFₓ; Co→CoF₃; CoF₂→CoF₃). This allows fabrication of very high voltage cells.

Furthermore, regarding interface stability, the ability to form the electrodes in situ allows the formation of good low impedance interfaces as the materials are generated in situ in direct contact with the electrolyte.

3.1. Electrochemical Battery Cells

According to another aspect, the described invention provides an electrochemical battery cell comprising:

(i) a positive electrode; wherein the positive electrode is capable of donating a fluoride ion;

(ii) a negative electrode; wherein the negative electrode is capable of accepting a fluoride ion;

(iii) an electrolyte comprising (HF)ₙF⁻ where n is from >0 to 10; wherein the electrolyte is capable of conducting a fluoride anion.

According to one embodiment, the electrochemical battery cell has an positive electrode capable of donating a fluoride ion reversibly. According to another embodiment, the electrochemical battery cell has a negative electrode capable of accepting a fluoride ion reversibly.

According to another embodiment, the positive electrode comprises carbon. According to another embodiment, the positive electrode comprises at least one carbon (HF)ₙF⁻ where n is from >0 to 10. According to another embodiment, the positive electrode comprises silver. According to another embodiment, the positive electrode comprises silver (HF)ₙF⁻ where n is from >0 to 10. According to another embodiment, the positive electrode comprises gold. According to another embodiment, the positive electrode comprises gold (HF)ₙF⁻ where n is from >0 to 10. According to another embodiment, the positive electrode comprises copper. According to another embodiment, the positive electrode comprises copper (HF)ₙF⁻ where n is from >0 to 10. According to another embodiment, the positive electrode comprises bismuth. According to another embodiment, the positive electrode comprises bismuth (HF)ₙF⁻ where n is from >0 to 10. According to another embodiment, the positive electrode comprises palladium. According to another embodiment, the positive electrode comprises palladium (HF)ₙF⁻ where n is from >0 to 10. According to another embodiment, the positive electrode comprises nanographite. According to another embodiment, the positive electrode comprises carbon nanotubes. According to another embodiment, the positive electrode comprises buckyballs. According to another embodiment, the positive electrode comprises mesoporous carbons. According to another embodiment, the positive electrode comprises microporous carbons.

According to another embodiment, the negative electrode comprises lanthanum. According to another embodiment, the negative electrode comprises lithium. According to another embodiment, the negative electrode comprises sodium. According to another embodiment, the negative electrode comprises calcium. According to another embodiment, the negative electrode comprises magnesium. According to another embodiment, the negative electrode comprises strontium. According to another embodiment, the negative electrode comprises barium. According to another embodiment, the negative electrode comprises potassium. According to another embodiment, the negative electrode comprises rubidium. According to another embodiment, the negative electrode comprises zinc. According to another embodiment, the negative electrode comprises aluminum. According to another embodiment, the negative electrode comprises silicon. According to another embodiment, the negative electrode comprises germanium.

According to another embodiment, the electrolyte comprises at least one bifluoride anion. According to another embodiment, the electrolyte comprises at least one bifluoride anion of formula ((F(HF)ₙ⁻) wherein n is from >0 to 10. According to another embodiment, the bifluoride anion is of the formula (F(HF)ₙ⁻), wherein n=1 or n>1. According to another embodiment, the bifluoride anion is (HF₂)⁻. According to another embodiment, the bifluoride anion is (HF₂)F⁻. According to another embodiment, the bifluoride anion is (HF)₃F⁻. According to another embodiment, the electrolyte comprises a plurality of bifluoride anions. According to another embodiment, the electrolyte comprises at least one of (HF₂)⁻, (HF₂)F⁻ and (HF)₃F⁻, or a combination thereof

According to another embodiment, the electrolyte comprises at least one bifluoride anion and at least one cation containing at least one organic compound. According to some such embodiments, the at least one bifluoride anion is of formula (HF)ₙF⁻ wherein n is from >0 to 10. According to some such embodiments, the at least one bifluoride anion is (HF)ₙF⁻ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride anion is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

According to some such embodiments, the electrolyte is a tetralkylammonium (HF)ₙF⁻ where n is from >0 to 10, and the alkyl is an alkyl from 1 to 10 carbon atoms. According to some embodiments, the electrolyte is a tetralkylammonium (HF)ₙF⁻ where n is from >0 to 10, and the alkyl is an alkyl of 1 carbon atom. According to some such embodiments, the electrolyte is a tetralkylammonium (HF)ₙF⁻ where n is from >0 to 10, and the alkyl is an alkyl of 2 carbon atoms. According to some such embodiments, the electrolyte is a tetralkylammonium (HF)ₙF⁻ where n is from >0 to 10, and the alkyl is an alkyl of 3 carbon atoms. According to some such embodiments, the electrolyte is a tetralkylammonium (HF)ₙF⁻ where n is from >0 to 10, and the alkyl is an alkyl of 4 carbon atoms. According to some such embodiments, the electrolyte is a tetralkylammonium (HF)ₙF⁻ where n is from >0 to 10, and the alkyl is an alkyl of 5 carbon atoms. According to some such embodiments, the electrolyte is a tetralkylammonium (HF)ₙF⁻ where n is from >0 to 10, and the alkyl is an alkyl of 6 carbon atoms. According to some such embodiments, the electrolyte is a tetralkylammonium (HF)ₙF⁻ where n is from >0 to 10, and the alkyl is an alkyl of 7 carbon atoms. According to some such embodiments, the electrolyte is a tetralkylammonium (HF)ₙF⁻ where n is from >0 to 10, and the alkyl is an alkyl of 8 carbon atoms. According to some such embodiments, the electrolyte is a tetralkylammonium (HF)ₙF⁻ where n is from >0 to 10, and the alkyl is an alkyl of 9 carbon atoms. According to some such embodiments, the electrolyte is a tetralkylammonium (HF)ₙF⁻ where n is from >0 to 10, and the alkyl is an alkyl of 10 carbon atoms. According to some such embodiments, the electrolyte is a tetraalkylammonium (HF)ₙF⁻ where n=1, and the alkyl is an alkyl of 1 to 10 carbon atoms. According to some such embodiments, the electrolyte is a tetraalkylammonium (HF)ₙF⁻ where n=2, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=4, and the alkyl is an alkyl of 1 to 10 carbon atoms. According to some such embodiments, the electrolyte is a tetraalkylammonium (HF)ₙF⁻ where n=5, and the alkyl is an alkyl of 1 to 10 carbon atoms. According to some such embodiments, the electrolyte is a tetraalkylammonium (HF)ₙF⁻ where n=6, and the alkyl is an alkyl of 1 to 10 carbon atoms. According to some such embodiments, the electrolyte is a tetraalkylammonium (HF)ₙF⁻ where n=7, and the alkyl is an alkyl of 1 to 10 carbon atoms. According to some such embodiments, the electrolyte is a tetraalkylammonium (HF)ₙF⁻ where n=8, and the alkyl is an alkyl of 1 to 10 carbon atoms. According to some such embodiments, the electrolyte is a tetraalkylammonium (HF)ₙF⁻ where n=9, and the alkyl is an alkyl of 1 to 10 carbon atoms. According to some such embodiments, the electrolyte is a tetraalkylammonium (HF)ₙF⁻ where n=10, and the alkyl is an alkyl of 1 to 10 carbon atoms.

According to some such embodiments, the electrolyte is tetraethyl ammonium (HF)ₙF⁻ (TEAF), where n is from >0 to 10. According to some such embodiments, the electrolyte is tetrapropyl ammonium (HF)ₙF⁻ where n is from >0 to 10. According to some such embodiments, the electrolyte is tetramethyl ammonium (HF)ₙF⁻ where n is from >0 to 10. According to another embodiment, the electrolyte comprises a plurality of (HF)ₙF⁻-containing organics, where n is from >0 to 10.

According to another embodiment, the electrolyte further comprises diphenylguanidium (HF)ₙF⁻ where n is from >0 to 10.

According to another embodiment, the electrolyte further comprises 1,3-dialkylimidazolium fluorogydrogenate ((HF)ₙF⁻) where n is from >0 to 10.

According to another embodiment, the electrolyte comprises at least one bifluoride anion and at least one inorganic cation. According to some such embodiments, the bifluoride anion is of the formula (HF)ₙF⁻ wherein n is from >0 to 10. According to some such embodiments, the at least one bifluoride anion is (HF)ₙF⁻ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride anion is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

According to another embodiment, the interface between the anode material and the electrolyte or the cathode material and the electrolyte comprises at least one additional electrolyte. Such additional electrolytes have a fluoride conductivity that is stable towards reduction or oxidation. According to some such embodiments, the at least one additional electrolyte is an inorganic.

According to some such embodiments, the at least one additional electrolyte is a solid state conductor.

According to some embodiments, the at least one additional electrolyte comprises a fluoride of a group II element. According to some such embodiments, the at least one additional electrolyte is a fluoride of calcium. According to some such embodiments, the at least one additional electrolyte is a fluoride of strontium. According to some such embodiments, the at least one additional electrolyte is a fluoride of barium. According to some embodiments, the at least one additional electrolyte comprises a fluoride of a lanthanoid element. According to some such embodiments, the at least one additional electrolyte is a fluoride of lanthanum. According to some embodiments, the at least one additional electrolyte comprises a fluoride of a group III element. According to some such embodiments, the at least one additional electrolyte is a fluoride of yttrium. According to some embodiments, the at least one additional electrolyte comprises a fluoride of a group I element. According to some such embodiments, the at least one additional electrolyte is a fluoride of potassium. According to some such embodiments, the at least one additional electrolyte is a fluoride of lithium. According to some such embodiments, the at least one additional electrolyte is a fluoride of sodium. According to some such embodiments, the at least one additional electrolyte is a fluoride of rubidium. According to some such embodiments, the at least one additional electrolyte is a fluoride of cesium.

3.2. Rechargeable Electrochemical Battery Cells

According to another aspect, the described invention provides a rechargeable electrochemical battery cell comprising:

(i) a negative electrode comprising a metal fluoride;

(ii) an electrolyte comprising (HF)ₙF− where n is from >0 to 10;

(iii) an optional additional electrolyte; and

(iv) a positive electrode comprising a compound of a low oxidation state, wherein the predominant diffusing species is a fluoride ion,

wherein the electrochemical battery cell is in a discharged state.

Such electrochemical battery cells are rechargeable.

According to one embodiment, the electrochemical cell receives a first charge and the negative electrode oxidizes upon receiving the first charge, thereby removing a fluoride ion and forming a negative electrode of high reactivity. According to some such embodiments, the negative electrode is a negative electrode comprising a lanthanoid element. According to some such embodiments, the negative electrode is a negative electrode comprising lanthanum. According to some such embodiments, the negative electrode is a negative electrode comprising a group I element. According to some such embodiments, the negative electrode is a negative electrode comprising lithium. According to some such embodiments, the negative electrode is a negative electrode comprising sodium. According to some such embodiments, the negative electrode is a negative electrode comprising potassium. According to some such embodiments, the negative electrode is a negative electrode comprising rubidium. According to some such embodiments, the negative electrode is a negative electrode comprising a Group II element. According to some such embodiments, the negative electrode is a negative electrode comprising calcium. According to some such embodiments, the negative electrode is a negative electrode comprising strontium. According to some such embodiments, the negative electrode is a negative electrode comprising barium.

According to another embodiment, the electrochemical battery cell receives a first charge and the positive electrode incorporates fluoride ions, thereby forming an oxidized positive electrode of high potential and capacity. According to some such embodiments, the positive electrode comprises carbon. According to some such embodiments, the positive electrode comprises silver. According to some such embodiments, the positive electrode comprises gold. According to some such embodiments, the positive electrode comprises copper. According to some such embodiments, the positive electrode comprises bismuth. According to some such embodiments, the positive electrode comprises palladium.

According to some embodiments, the positive electrode comprises nanostructured carbon. According to some such embodiments, the nanostructured carbon is nanographite. According to some such embodiments, the nanostructured carbon is a carbon nanotube. According to some such embodiments, the nanostructured carbon is a buckyball. According to some such embodiments, the nanostructured carbon is a mesoporous carbon. According to some such embodiments, the nanostructured carbon is a microporous carbon.

According to some embodiments, the positive electrode is a positive electrode that is partially oxidized. According to some such embodiments, the positive electrode that is partially oxidized is brought to a higher state of fluorination and oxidation during the first formation charge. According to some such embodiments, the positive electrode that is partially oxidized and is brought to a higher state of fluorination and oxidation during the first formation charge is a BiF₃ electrode. According to some such embodiments, the positive electrode that is partially oxidized and is brought to a higher state of fluorination and oxidation during the first formation charge is a bismuth oxyfluoride electrode. According to some such embodiments, the positive electrode that is partially oxidized and is brought to a higher state of fluorination and oxidation during the first formation charge is a CuF₂ electrode. According to some such embodiments, the positive electrode that is partially oxidized and is brought to a higher state of fluorination and oxidation during the first formation charge is a MnF₂ electrode. According to some such embodiments, the positive electrode that is partially oxidized and is brought to a higher state of fluorination and oxidation during the first formation charge is a NiF₂ electrode. According to some such embodiments, the positive electrode that is partially oxidized and is brought to a higher state of fluorination and oxidation during the first formation charge is a CoF₂ electrode. According to some such embodiments, the positive electrode that is partially oxidized and is brought to a higher state of fluorination and oxidation during the first formation charge is a CFₓ electrode, where x<1. According to some such embodiments, the positive electrode that is partially oxidized and is brought to a higher state of fluorination and oxidation during the first formation charge is a AgF electrode. According to some such embodiments, the positive electrode that is partially oxidized and is brought to a higher state of fluorination and oxidation during the first formation charge is a first row transition metal oxide electrode. According to some such embodiments, the positive electrode that is partially oxidized and is brought to a higher state of fluorination and oxidation during the first formation charge is a silver oxide electrode.

According to another embodiment, the electrolyte is a solid state fluoride conductor.

According to another embodiment, the electrolyte comprises at least one bifluoride anion. According to another embodiment, the at least one bifluoride anion is of the formula (F(HF)ₙ⁻), wherein n is from >0 to 10. According to another embodiment, the at least one bifluoride anion is of the formula (F(HF)ₙ⁻), wherein n=1 or n>1. According to another embodiment, the at least one bifluoride anion is (HF₂)⁻. According to another embodiment, the at least one bifluoride anion is (HF₂)F⁻. According to another embodiment, the bifluoride anion is (HF)₃F⁻. According to another embodiment, the electrolyte comprises a plurality of bifluoride anions. According to another embodiment, the electrolyte comprises at least one of (HF₂)⁻, (HF₂)F⁻ and (HF)₃F⁻, or a combination thereof

According to another embodiment, the electrolyte comprises at least one bifluoride anion and at least one cation containing at least one organic compound. According to some such embodiments, the at least one bifluoride anion is of the formula (F(HF)ₙ⁻), wherein n is from >0 to 10. According to some such embodiments, the at least one bifluoride anion is (HF)ₙF⁻ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride anion is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

According to some such embodiments, the electrolyte is a tetralkylammonium (HF)ₙF⁻ where n is from >0 to 10, and the alkyl is an alkyl from 1 to 10 carbons. According to some embodiments, the electrolyte is a tetralkylammonium (HF)ₙF⁻ where n is from >0 to 10, and the alkyl is an alkyl of 1 carbon atom. According to some such embodiments, the electrolyte is a tetralkylammonium (HF)ₙF⁻ where n is from >0 to 10, and the alkyl is an alkyl of 2 carbon atoms. According to some such embodiments, the electrolyte is a tetralkylammonium (HF)ₙF⁻ where n is from >0 to 10, and the alkyl is an alkyl of 3 carbon atoms. According to some such embodiments, the electrolyte is a tetralkylammonium (HF)ₙF⁻ where n is from >0 to 10, and the alkyl is an alkyl of 4 carbon atoms. According to some such embodiments, the electrolyte is a tetralkylammonium (HF)ₙF⁻ where n is from >0 to 10, and the alkyl is an alkyl of 5 carbon atoms. According to some such embodiments, the electrolyte is a tetralkylammonium (HF)ₙF⁻ where n is from >0 to 10, and the alkyl is an alkyl of 6 carbon atoms. According to some such embodiments, the electrolyte is a tetralkylammonium (HF)ₙF⁻ where n is from >0 to 10, and the alkyl is an alkyl of 7 carbon atoms. According to some such embodiments, the electrolyte is a tetralkylammonium (HF)ₙF⁻ where n is from >0 to 10, and the alkyl is an alkyl of 8 carbon atoms. According to some such embodiments, the electrolyte is a tetralkylammonium (HF)ₙF⁻ where n is from >0 to 10, and the alkyl is an alkyl of 9 carbon atoms. According to some such embodiments, the electrolyte is a tetralkylammonium (HF)ₙF⁻ where n is from >0 to 10, and the alkyl is an alkyl of 10 carbon atoms. According to some such embodiments, the electrolyte is a tetraalkylammonium (HF)ₙF⁻ where n=1, and the alkyl is an alkyl of 1 to 10 carbon atoms. According to some such embodiments, the electrolyte is a tetraalkylammonium (HF)ₙF⁻ where n=2, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=4, and the alkyl is an alkyl of 1 to 10 carbon atoms. According to some such embodiments, the electrolyte is a tetraalkylammonium (HF)ₙF⁻ where n=5, and the alkyl is an alkyl of 1 to 10 carbon atoms. According to some such embodiments, the electrolyte is a tetraalkylammonium (HF)ₙF⁻ where n=6, and the alkyl is an alkyl of 1 to 10 carbon atoms. According to some such embodiments, the electrolyte is a tetraalkylammonium (HF)ₙF⁻ where n=7, and the alkyl is an alkyl of 1 to 10 carbon atoms. According to some such embodiments, the electrolyte is a tetraalkylammonium (HF)ₙF⁻ where n=8, and the alkyl is an alkyl of 1 to 10 carbon atoms. According to some such embodiments, the electrolyte is a tetraalkylammonium (HF)ₙF⁻ where n=9, and the alkyl is an alkyl of 1 to 10 carbon atoms. According to some such embodiments, the electrolyte is a tetraalkylammonium (HF)ₙF⁻ where n=10, and the alkyl is an alkyl of 1 to 10 carbon atoms.

According to some such embodiments, the electrolyte is tetraethyl ammonium (HF)ₙF⁻ (TEAF), where n is from >0 to 10. According to some such embodiments, the electrolyte is tetrapropyl ammonium (HF)ₙF⁻ where n is from >0 to 10. According to some such embodiments, the electrolyte is tetramethyl ammonium (HF)ₙF⁻ where n is from >0 to 10. According to another embodiment, the electrolyte comprises a plurality of (HF)ₙF⁻ containing organics, where n is from >0 to 10.

According to another embodiment, the electrolyte further comprises diphenylguanidium (HF)ₙF⁻ where n is from >0 to 10.

According to another embodiment, the electrolyte further comprises 1,3-dialkylimidazolium fluorogydrogenate ((HF)ₙF⁻) where n is from >0 to 10.

According to another embodiment, the electrolyte comprises at least one bifluoride anion and at least one inorganic cation. According to some such embodiments, the at least one bifluoride anion is (HF)ₙF⁻ where n is from >0 to 10. According to some such embodiments, the at least one bifluoride anion is (HF)ₙF₋ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride anion is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

According to another embodiment, the electrochemical battery cell operates at a voltage greater than or equal to 4V. According to another embodiment, the charged electrochemical battery cell operates at a voltage greater than or equal to 5V.

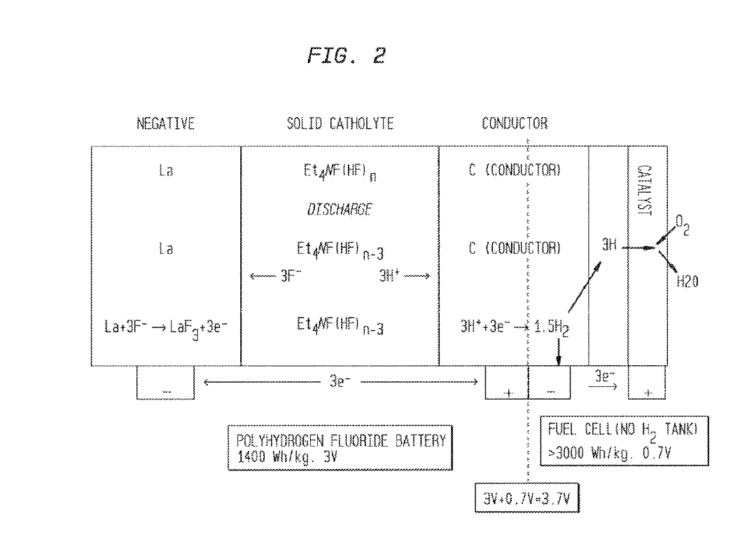

According to another embodiment, to store the produced hydrogen for use during the recharge reaction to reform polyhydrogen ions, the cathode can contain a material that will readily form a hydride. FIG. 2 shows a nonlimiting embodiment of the described rechargeable electrochemical battery cell of FIG. 1A wherein the hydrogen produced may be fed into a fuel cell that is either discreet or integrated into the electrochemical battery cell. This can be configured by the incorporation of a proton conducting membrane that conducts protons to the catalytic cathode, which induces a reaction between the proton and the ambient oxygen to form water as a reduction product. The incorporation of the fuel cell component in series can raise the voltage of the polyhydrogen fluoride battery by 0.7V and increase the energy density to over 3500 Wh/kg.

### 4. Methods of Fabricating a Rechargeable Electrochemical Battery Cell

According to another aspect, the described invention provides a method of fabricating a rechargeable electrochemical battery cell, the method comprising steps:

(1) providing an electrochemical battery cell comprising:

(a) a negative electrode comprising a metal fluoride;

(b) an electrolyte comprising (HF)ₙF⁻ where n is from >0 to 10;

(c) an optional additional electrolyte;

(d) a positive electrode comprising a compound of a low oxidation state, wherein a predominant diffusing species is a fluoride ion, and

wherein the electrochemical battery cell is in a discharged state;

(2) administering a first formation charge;

(3) oxidizing the negative electrode, wherein oxidizing the negative electrode removes fluoride ions;

(4) incorporating fluoride ions into the positive electrode, wherein the positive electrode forms an oxidized positive electrode; and

(5) forming a charged electrochemical battery cell.

According to one embodiment, the electrochemical battery cell of step (1) is of a partially discharged state.

According to some such embodiments, the negative electrode is a negative electrode comprising a lanthanoid. According to some such embodiments, the negative electrode is a negative electrode comprising lanthanum. According to some such embodiments, the negative electrode is a negative electrode comprising a Group I element. According to some such embodiments, the negative electrode is a negative electrode comprising lithium. According to some such embodiments, the negative electrode is a negative electrode comprising sodium. According to some such embodiments, the negative electrode is a negative electrode comprising potassium. According to some such embodiments, the negative electrode is a negative electrode comprising rubidium. According to some such embodiments, the negative electrode is a negative electrode comprising a Group II element. According to some such embodiments, the negative electrode is a negative electrode comprising calcium. According to some such embodiments, the negative electrode is a negative electrode comprising strontium. According to some such embodiments, the negative electrode is a negative electrode comprising barium.

According to some such embodiments, the positive electrode comprises carbon. According to some such embodiments, the positive electrode comprises silver. According to some such embodiments, the positive electrode comprises gold. According to some such embodiments, the positive electrode comprises copper. According to some such embodiments, the positive electrode comprises bismuth. According to some such embodiments, the positive electrode comprises palladium.

According to some embodiments, the positive electrode comprises nanostructured carbon. According to some such embodiments, the nanostructured carbon is nanographite. According to some such embodiments, the nanostructured carbon is a carbon nanotube. According to some such embodiments, the nanostructured carbon is a buckyball. According to some such embodiments, the nanostructured carbon is a mesoporous carbon. According to some such embodiments, the nanostructured carbon is a microporous carbon.

According to some embodiments, the positive electrode of step (1) is a positive electrode that is partially oxidized. According to some such embodiments, the positive electrode of step (1) is a BiF₃ electrode. According to some such embodiments, the positive electrode of step (1) is a bismuth oxyfluoride electrode. According to some such embodiments, the positive electrode of step (1) is a CuF₂ electrode. According to some such embodiments, the positive electrode of step (1) is a MnF₂ electrode. According to some such embodiments, the positive electrode of step (1) is a NiF₂ electrode. According to some such embodiments, the positive electrode of step (1) is a CoF₂ electrode. According to some such embodiments, the positive electrode of step (1) is a CFₓ electrode where x<1. According to some such embodiments, the positive electrode of step (1) is a AgF electrode. According to some such embodiments, the positive electrode of step (1) is a first row transition metal oxide electrode. According to some such embodiments, the positive electrode of step (1) is a silver oxide electrode.

According to another embodiment, the electrolyte is a solid state fluoride conductor.

According to another embodiment, the electrolyte comprises at least one bifluoride anion. According to another embodiment, the at least one bifluoride anion is of the formula (F(HF)ₙ⁻), wherein n is from >0 to 10. According to another embodiment, the at least one bifluoride anion is of the formula (F(HF)ₙ⁻), wherein n=1 or n>1. According to another embodiment, the at least one bifluoride anion is (HF₂)⁻. According to another embodiment, the at least one bifluoride anion is (HF₂)F⁻. According to another embodiment, the at least one bifluoride anion is (HF)₃F⁻. According to another embodiment, the electrolyte comprises a plurality of bifluoride anions. According to another embodiment, the electrolyte comprises at least one of (HF₂)⁻, (HF₂)F⁻ and (HF)₃F⁻, or a combination thereof.

According to another embodiment, the electrolyte comprises at least one bifluoride anion and at least one cation containing at least one organic compound. According to some such embodiments, the at least one bifluoride anion is of the formula ((HF)ₙF⁻), wherein n is from >0 to 10. According to some such embodiments, the at least one bifluoride anion is (HF)ₙF⁻ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride anion is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

According to some such embodiments, the electrolyte is a tetralkylammonium (HF)ₙF⁻ where n is from >0 to 10, and the alkyl is an alkyl from 1 to 10 carbons. According to some embodiments, the electrolyte is a tetralkylammonium (HF)ₙF⁻ where n is from >0 to 10, and the alkyl is an alkyl of 1 carbon atom. According to some such embodiments, the electrolyte is a tetralkylammonium (HF)ₙF⁻ where n is from >0 to 10, and the alkyl is an alkyl of 2 carbon atoms. According to some such embodiments, the electrolyte is a tetralkylammonium (HF)ₙF⁻ where n is from >0 to 10, and the alkyl is an alkyl of 3 carbon atoms. According to some such embodiments, the electrolyte is a tetralkylammonium (HF)ₙF⁻ where n is from >0 to 10, and the alkyl is an alkyl of 4 carbon atoms. According to some such embodiments, the electrolyte is a tetralkylammonium (HF)ₙF⁻ where n is from >0 to 10, and the alkyl is an alkyl of 5 carbon atoms. According to some such embodiments, the electrolyte is a tetralkylammonium (HF)ₙF⁻ where n is from >0 to 10, and the alkyl is an alkyl of 6 carbon atoms. According to some such embodiments, the electrolyte is a tetralkylammonium (HF)ₙF⁻ where n is from >0 to 10, and the alkyl is an alkyl of 7 carbon atoms. According to some such embodiments, the electrolyte is a tetralkylammonium (HF)ₙF⁻ where n is from >0 to 10, and the alkyl is an alkyl of 8 carbon atoms. According to some such embodiments, the electrolyte is a tetralkylammonium (HF)ₙF⁻ where n is from >0 to 10, and the alkyl is an alkyl of 9 carbon atoms. According to some such embodiments, the electrolyte is a tetralkylammonium (HF)ₙF⁻ where n is from >0 to 10, and the alkyl is an alkyl of 10 carbon atoms. According to some such embodiments, the electrolyte is a tetraalkylammonium (HF)ₙF⁻ where n=1, and the alkyl is an alkyl of 1 to 10 carbon atoms. According to some such embodiments, the electrolyte is a tetraalkylammonium (HF)ₙF⁻ where n=2, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=3, and the alkyl is an alkyl of 1 to 10 carbon atoms. According to some such embodiments, the electrolyte is a tetraalkylammonium (HF)ₙF⁻ where n=4, and the alkyl is an alkyl of 1 to 10 carbon atoms. According to some such embodiments, the electrolyte is a tetraalkylammonium (HF)ₙF⁻ where n=5, and the alkyl is an alkyl of 1 to 10 carbon atoms. According to some such embodiments, the electrolyte is a tetraalkylammonium (HF)ₙF⁻ where n=6, and the alkyl is an alkyl of 1 to 10 carbon atoms. According to some such embodiments, the electrolyte is a tetraalkylammonium (HF)ₙF⁻ where n=7, and the alkyl is an alkyl of 1 to 10 carbon atoms. According to some such embodiments, the electrolyte is a tetraalkylammonium (HF)ₙF⁻ where n=8, and the alkyl is an alkyl of 1 to 10 carbon atoms. According to some such embodiments, the electrolyte is a tetraalkylammonium (HF)ₙF⁻ where n=9, and the alkyl is an alkyl of 1 to 10 carbon atoms. According to some such embodiments, the electrolyte is a tetraalkylammonium (HF)ₙF⁻ where n=10, and the alkyl is an alkyl of 1 to 10 carbon atoms.

According to some such embodiments, the electrolyte is tetraethyl ammonium (HF)ₙF⁻ (TEAF), where n is from >0 to 10. According to some such embodiments, the electrolyte is tetrapropyl ammonium (HF)ₙF⁻ where n is from >0 to 10. According to some such embodiments, the electrolyte is tetramethyl ammonium (HF)ₙF⁻ where n is from >0 to 10. According to another embodiment, the electrolyte comprises a plurality of (HF)ₙF⁻ containing organics, where n is from >0 to 10.

According to another embodiment, the electrolyte further comprises diphenylguanidium (HF)ₙF⁻ where n is from >0 to 10.

According to another embodiment, the electrolyte further comprises 1,3-dialkylimidazolium fluorogydrogenate ((HF)ₙF⁻) where n is from >0 to 10.

According to another embodiment, the electrolyte comprises at least one bifluoride anion and at least one inorganic cation. According to some such embodiments, the at least one bifluoride anion is (HF)ₙF₋ where n is from >0 to 10. According to some such embodiments, the at least one bifluoride anion is (HF)ₙF₋ where n=1. According to some such embodiments, the at least one bifluoride anion is (HF)ₙF⁻ where n=2. According to some such embodiments, the at least one bifluoride anion is (HF)ₙF⁻ where n=3. According to some such embodiments, the at least one bifluoride anion is (HF)ₙF⁻ where n=4. According to some such embodiments, the at least one bifluoride anion is (HF)ₙF⁻ where n=5. According to some such embodiments, the at least one bifluoride anion is (HF)ₙF⁻ where n=6. According to some such embodiments, the at least one bifluoride anion is (HF)ₙF⁻ where n=7. According to some such embodiments, the at least one bifluoride anion is (HF)ₙF⁻ where n=8. According to some such embodiments, the at least one bifluoride anion is (HF)ₙF⁻ where n=9. According to some such embodiments, the at least one bifluoride anion is (HF)ₙF⁻ where n=10.

According to some such embodiments, the at least one additional electrolyte is a solid state conductor.

According to some such embodiments, the at least one additional electrolyte is a fluoride of a group II element. According to some such embodiments, the at least one additional electrode is a fluoride of calcium. According to some such embodiments, the at least one additional electrolyte is a fluoride of strontium. According to some such embodiments, the at least one additional electrolyte is a fluoride of barium. According to some such embodiments, the at least one additional electrolyte is a fluoride of a lanthanoid. According to some such embodiments, the at least one additional electrolyte is a fluoride of lanthanum. According to some such embodiments, the at least one additional electrolyte is a fluoride of a Group III element. According to some such embodiments, the at least one additional electrolyte is a fluoride of yttrium. According to some such embodiments, the at least one additional electrolyte is a fluoride of a Group I element. According to some such embodiments, the at least one additional electrolyte is a fluoride of potassium. According to some such embodiments, the at least one additional electrolyte is a fluoride of lithium. According to some such embodiments, the at least one additional electrolyte is a fluoride of sodium. According to some such embodiments, the at least one additional electrolyte is a fluoride of rubidium. According to some such embodiments, the at least one additional electrolyte is a fluoride of cesium.

According to another embodiment, the charged electrochemical battery cell operates at a voltage greater than or equal to 3V. According to another embodiment, the charged electrochemical battery cell operates at a voltage greater than or equal to 4V. According to another embodiment, the charged electrochemical battery cell operates at a voltage greater than or equal to 5V.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges which may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any method and materials similar or equivalent to those described herein can also be used in the practice or testing of the present invention, the preferred methods and materials are now described. All publications mentioned herein are incorporated herein by reference to disclose and described the methods and/or materials in connection with which the publications are cited.

It must be noted that as used herein and in the appended claims, the singular forms “a”, “and”, and “the” include plural references unless the context clearly dictates otherwise. All technical and scientific terms used herein have the same meaning

The publications discussed herein are provided solely for their disclosure prior to the filing date of the present application. Nothing herein is to be considered as an admission that the present invention is not entitled to antedate such publication by virtue of prior invention. Further, the dates of publication provided may be different from the actual publication dates which may need to be independently confirmed.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1

### Fabrication of Tetraethyl Ammonium Hydrogen Bifluoride (TEAF)

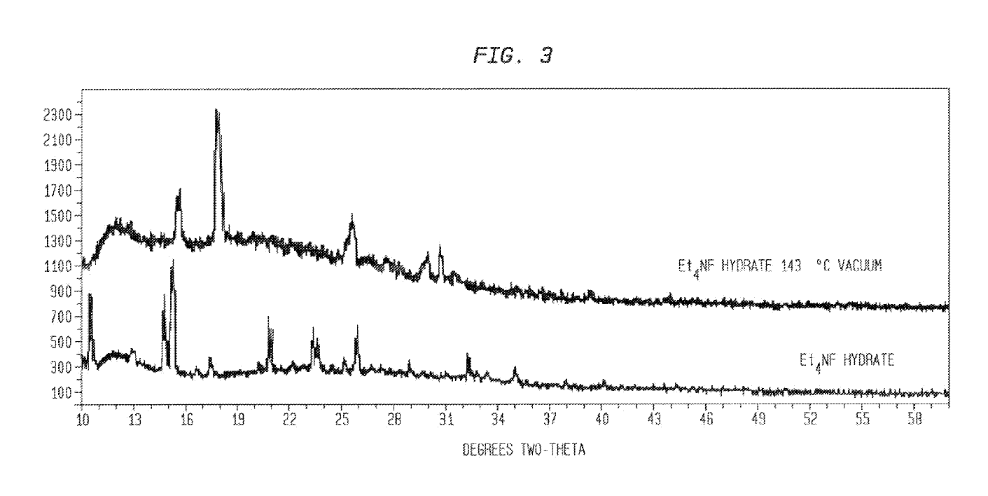

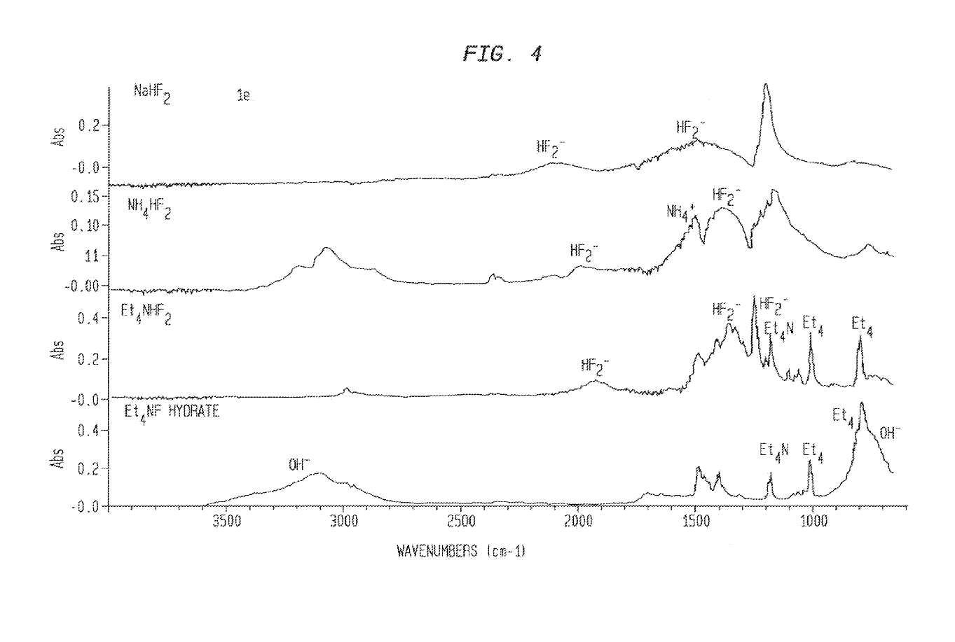

A bifluoride-containing organic, namely tetraethyl ammonium hydrogen bifluoride (HF)ₙF⁻ (denoted TEAF) was fabricated through the annealing of tetraethyl ammonium fluoride hydrate at 140° C. under a vacuum of approximately 0.1 Torr for 12 hours in a helium filled glovebox antechamber. Afterwards, the material was placed inside the glovebox without any exposure to air. All handling of the material was carried out in the helium filled glovebox at approximately −80° C. dewpoint. The dried material was a crystalline solid. FIG. 3 shows X-ray diffraction patterns of (1) the original tetraethylammonium fluoride hydrate and (2) the resulting product after annealing in a sealed environment at 143° C. The material was analyzed by Fourier transform infrared spectroscopy (“FTIR”). FIG. 4 shows plots of absorbance (Abs) versus wavenumbers (cm⁻¹) from FTIR of the original tetraethylammonium fluoride hydrate, the resulting product after annealing under vacuum at 143° C., and bifluoride standards NaHF₂ and NH₄HF₂. The FTIR spectra of the resulting product after annealing under vacuum at 143° C. shows that, along with bands assigned to the organic cation, are an underlying strong, broad band at approximately 1450 cm⁻¹, a weak broad band at approximately 1900 cm⁻¹, and a narrow strong band at approximately 1230 cm⁻¹; these are known as evidence of a significant presence of the difluoride anion (HF₂)⁻. This conclusion is further supported by comparison with the FTIR spectra of other known bifluoride-containing materials, NaHF₂ and NH₄HF₂.

Ionic conductivity of the TEAF powder was characterized by AC impedance spectroscopy of a pressed pellet of the powder fabricated in a Swagelok® cell with two stainless steel electrodes. The resulting ionic conductivity of the solid state pellet was shown to be a significant 1×10⁻⁶ Siemens (S)/cm. Thus, this example establishes the significant ionic conductivity of the fabricated TEAF material.

### Example 2

### Fabrication of an Electrochemical Battery Cell

### Example 2.1

### CF_{1.1} Cathode Material

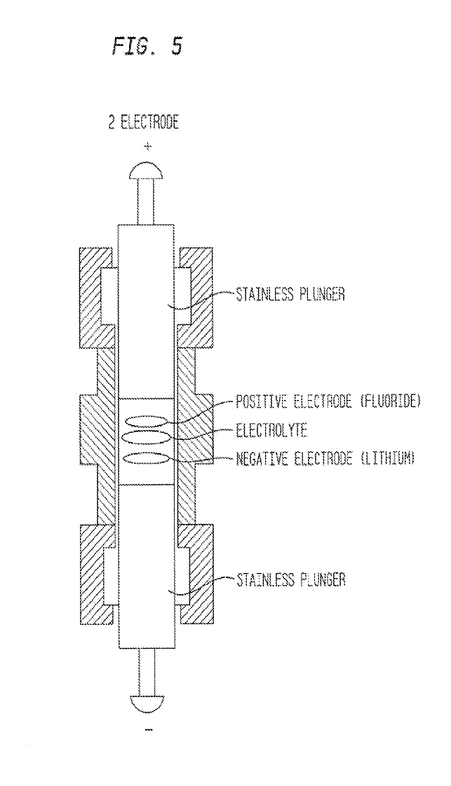

An electrochemical battery cell was fabricated to analyze the electrochemical viability of the fabricated TEAF material in a fluoride ion cell. FIG. 5 shows an illustrative schematic design of the two electrode test cell. A cell was fabricated by placing a 1 cm² piece of lithium metal as the anode material followed by a compressed layer of TEAF as the electrolyte with a thickness of approximately 0.3 mm. Afterwards a pressed composite of electrode of carbon fluoride (CF_{1.1}), approximately 3% of SP carbon and 20% of TEAF was pressed on top of the Li/TEAF cell. The total weight of active material was approximately 4 mg. The cell was placed at 70° C. and discharged at a current of 2.5 μA. The cell was fabricated in a He filled glovebox and sealed before removal.

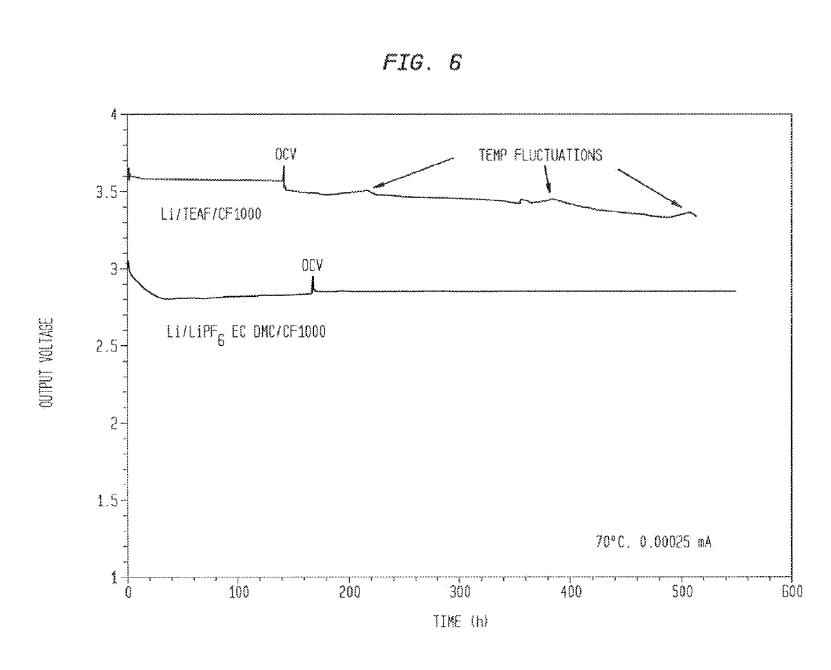

FIG. 6 shows the discharge profiles of the TEAF material and a standard lithium cell as plots of the output voltage versus time (hours). Both were fabricated with the identical CF_{1.1} cathode material and cycled under identical conditions. The resulting discharge profile shows that the fabricated TEAF cell had a high discharge potential of 3.8V to 3.2V, which is from 0.5V to 1V higher than what is found in a comparable state of the art Li/LiPF₆ EC:DMC/CF_{1.1} cell prepared by traditional techniques.

### Example 2.2

### CF_{0.8} Cathode Material

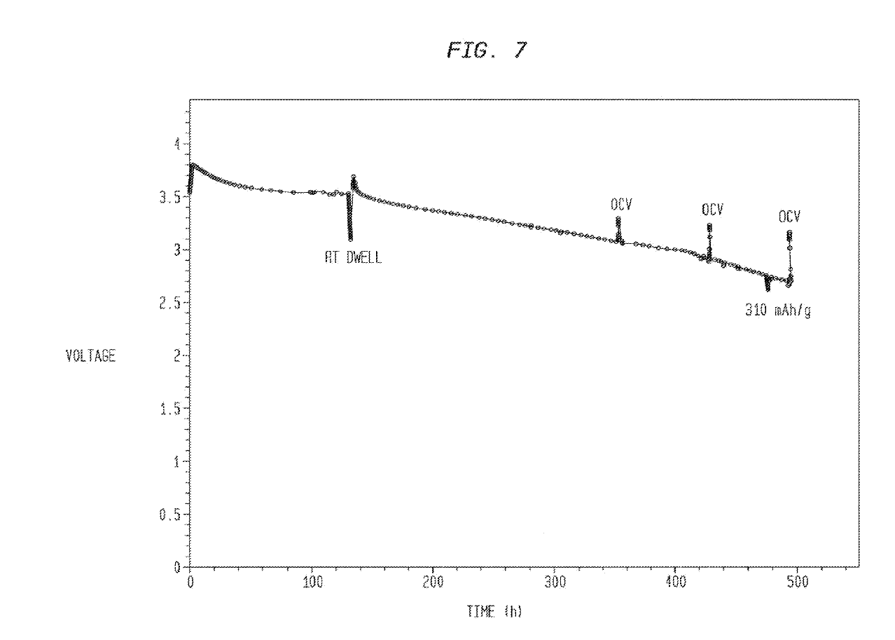

An electrochemical battery cell was fabricated by the technique described in Example 2.1, however, a cathode comprising CF_{0.8} was utilized instead of CF_{1.1}. FIG. 7 shows a plot of voltage versus time (hours) of the fabricated cell utilizing the CF_{0.8} cathode material discharged using conditions identical to those of the electrochemical battery cells in Example 2.1. FIG. 7 shows that the electrochemical battery cell comprising CF_{0.8} cathode material also demonstrated high discharge potential and excellent capacity. The electrochemical battery cell was stopped before end of life to examine the electrodes by x-ray diffraction. The x-ray diffraction results indicated the formation of LiF (data not shown), consistent with the expected negative electrode reaction Li+F⁻→LiF+e⁻.

### Example 2.3

### Nanocomposite BiF₃ and 15% Carbon Cathode Material

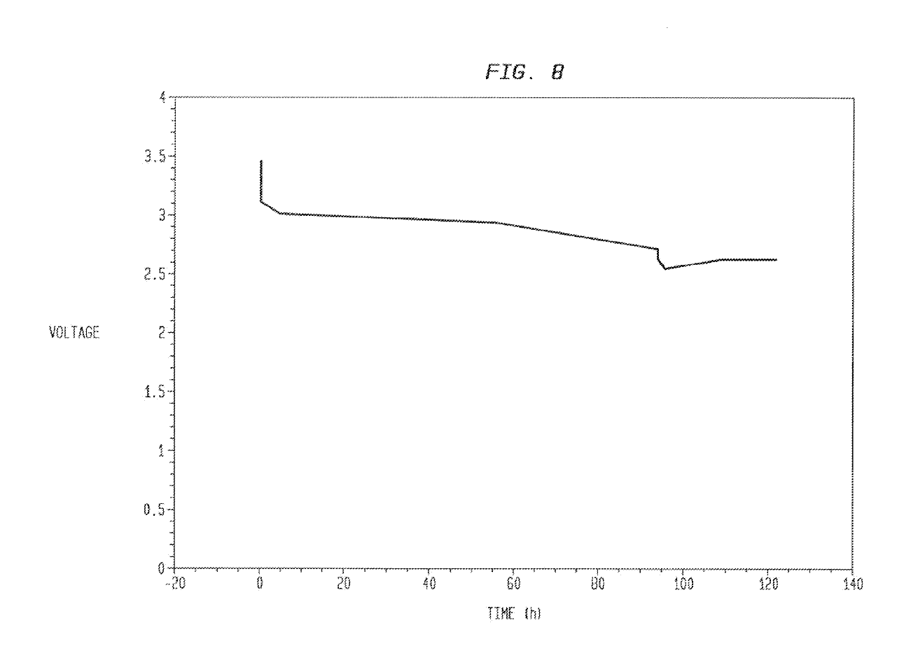

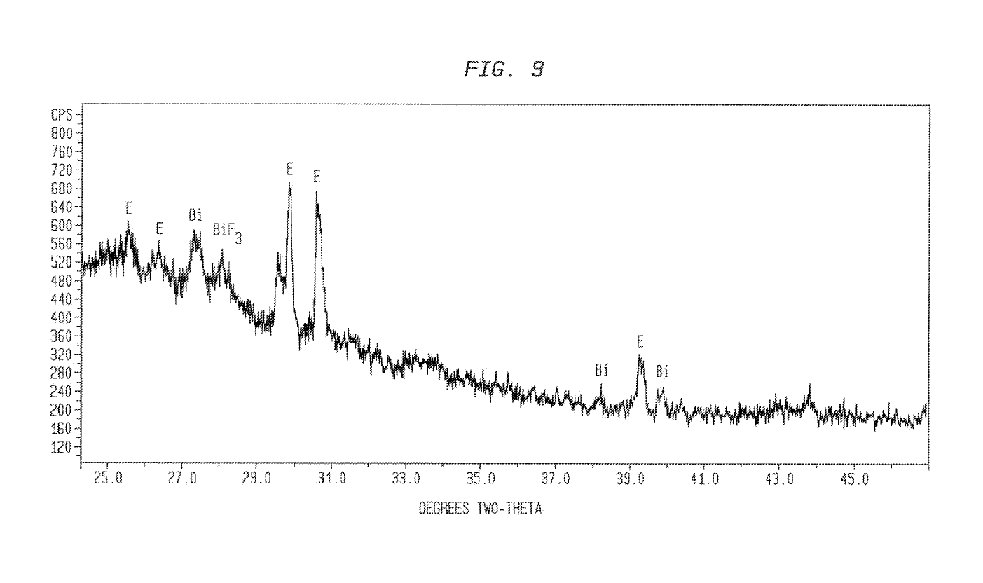

An electrochemical battery cell was fabricated by the technique outlined in Example 2.1 utilizing a cathode of nanocomposite BiF₃ (bismuth trifluoride)+15% carbon to demonstrate the effectiveness using a metal fluoride positive electrode. The electrochemical battery cell was discharged. FIG. 8 shows a plot of voltage versus time (hours) of the fabricated cell utilizing a BiF₃ composite cathode as the positive electrode. The fabricated cell showed significant capacity. Afterwards, the fabricated cell was removed, disassembled in a helium filled glovebox, and the cathode material analyzed by x-ray diffraction. FIG. 9 shows a plot of the X-ray diffraction pattern of the partially discharged cathode. The results show a partial defluorination and reduction of the BiF₃ composite to Bi. X-ray diffraction analysis of the Li negative electrode showed the transformation of Li to LiF (data not shown). These results are consistent with an electrochemical battery cell operating via a F⁻ ionic transfer, i.e., a fluoride ion battery.

### Example 3

### Three Electrode Electrochemical Battery Cells

### Example 3.1

### Li/TEAF/CF_{1.1} Three Electrode Cell

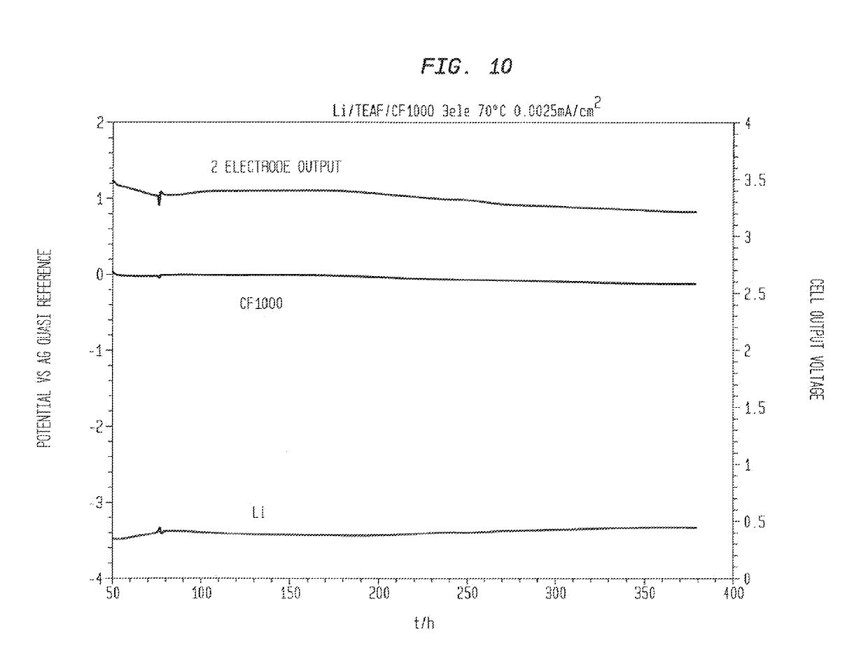

A three electrode electrochemical battery cell was fabricated using silver as a quasi reference electrode. The method of fabrication of such electrochemical battery cell was similar to Example 2.1 except that a reference electrode was placed within the TEAF electrolyte layer, which enabled the monitoring of the positive and negative electrode voltages separately during the discharge. FIG. 10 shows a plot of the output voltages recorded from the fabricated electrochemical battery cell and the individual potentials of Li versus the silver quasi reference (−3.5V), CF_{1.1} versus the silver quasi reference (approximately −0.2V), and the output voltage (the difference between the reference potentials). The plot shows that the discharge of the CFₓ electrode is very flat and that the slight decrease in the cell output voltage is due to a slight rise in the voltage of the lithium presumably due to the formation of LiF during discharge.

### Example 3.2

### Pb/TEAF/CF_{1.1} Three Electrode Cell

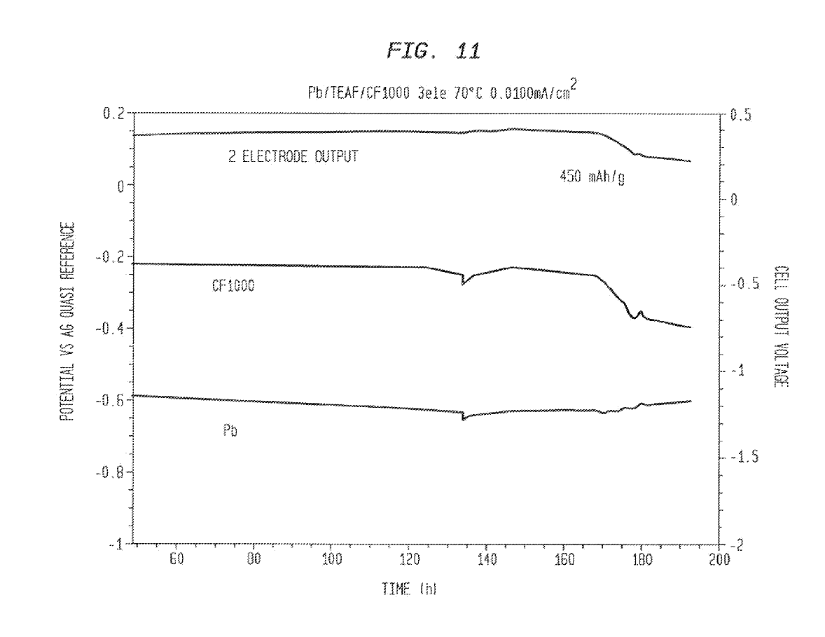

A three electrode electrochemical battery cell was fabricated in similar fashion to that of Example 3.1 except that a negative electrode of lead (Pb) was utilized instead of Li. The utilization of Pb further proves that the reduction process at the positive electrode is not due to Li ion transfer. The reactions occurring at the positive electrode in a cell using a Pb negative electrode are identical to the positive electrode reaction occurring in a cell with a Li negative electrode (see (4)). The PbF₂ formed has faster kinetics than LiF. FIG. 11 shows a plot of voltages recorded from the fabricated electrochemical battery cell and the individual potentials of Pb versus the silver quasi reference, CF_{1.1} versus the silver quasi reference, and the output voltage. The voltage of the positive electrode was identical as was seen with the Li example (Example 3.1) (−0.2V versus the silver reference). The voltage of the Pb negative electrode was approximately −0.6V. This resulted in a cell output voltage of 0.8V. Partial specific capacity of the positive electrode was significant (>450 mAh/g), even at higher rates of 10 μA/cm².

### Example 4

### Fabrication of Hydrogen BiFluoride Electrolytes

### Example 4.1

### Tetraethyl, Tetrapropyl and Tetraethyl Hydroxide/HF Electrolytes

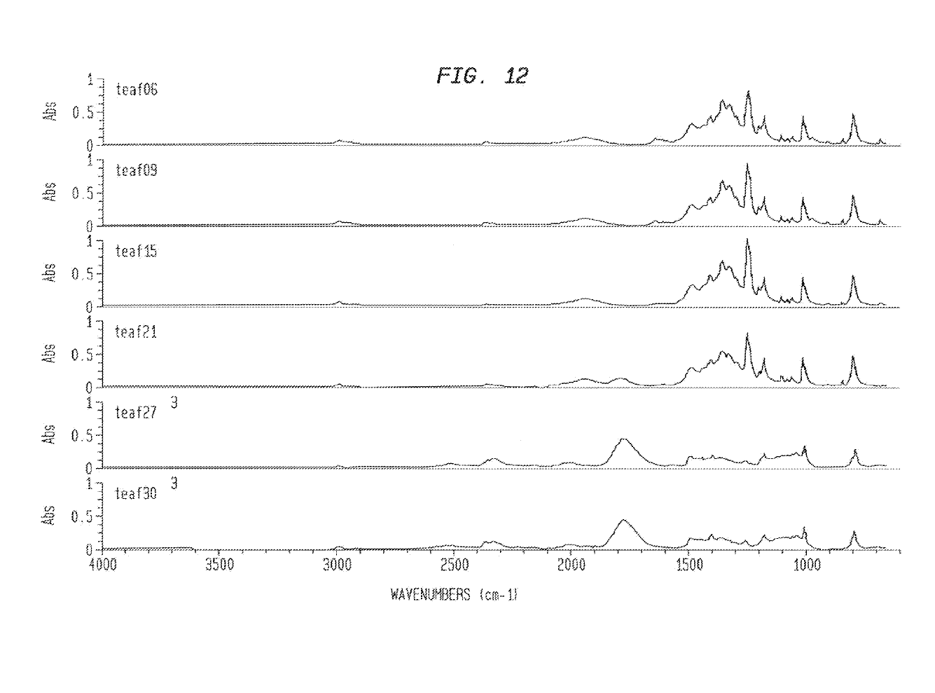

Electrolytes were fabricated by reacting tetraethyl, tetrapropyl, or tetraethyl hydroxide solutions with differing amounts of 48% HF solution. The solution was dried at 90° C. in ambient air followed by annealing under vacuum at 143° C. as described in Example 1. 10 ml of tetraethyl ammonium hydroxide (35% in H₂O) was mixed with 0.3 ml, 0.6 ml, 0.7 ml, 0.9 ml, 1.5 ml, 2.1 ml, 2.2 ml, 2.7 ml, and 3.0 ml of 48 wt % HF solution in separate teflon chambers. The materials were dried at 90° C. for a period of 8 hours. The dried materials were removed, and then placed in borosilicate vials. The vials were placed in a vacuum antechamber and heated for 12 hours at 143° C. under approximately 0.1 mTorr vacuum. After vacuum drying, the materials immediately were introduced into a He filled glovebox without exposure to air. No samples etched the borosilicate vials before or during the drying process. This suggests the presence of little or no free HF, rather the HF is entrapped within the crystal structure as an n(HF)F⁻ ion. FIG. 12 shows FTIR spectra (absorbance versus wavenumbers (cm⁻¹)) of the fabricated electrolytes teaf06, teaf09, teaf15, teaf21, teaf27 and teaf30. Samples teaf06, teaf09 and teaf15 (the number refers to ml of HF used X10) displayed no major change amongst their FTIR spectrum patterns. Teaf21 displayed a similar FTIR spectrum to those of teaf06, teaf09, and teaf15, however a new band begins to develop at approximately 1720 cm⁻¹. This band is indicative of a second phase, which fully develops in samples teaf 27 and teaf30.

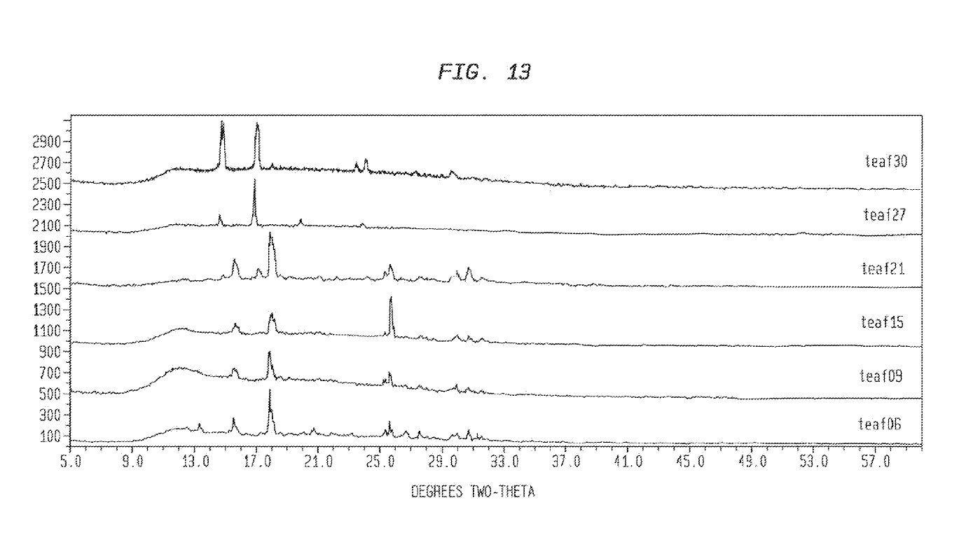

FIG. 13 shows X-ray diffraction patterns of the fabricated electrolytes teaf06, teaf09, teaf15, teaf21, teaf27 and teaf30. The series teaf06, teaf09, and teaf15 show small but significant changes in the overall crystalline structure of the material by x-ray diffraction, in contrast to the small change identified in the local structure by FTIR. Within the XRD data, a small second phase develops at approximately 14.5 and 16.5 degrees two theta, consistent with the teaf21 result of the FTIR. This crystal structure then becomes predominant in the teaf21, teaf 27 and teaf30 samples.

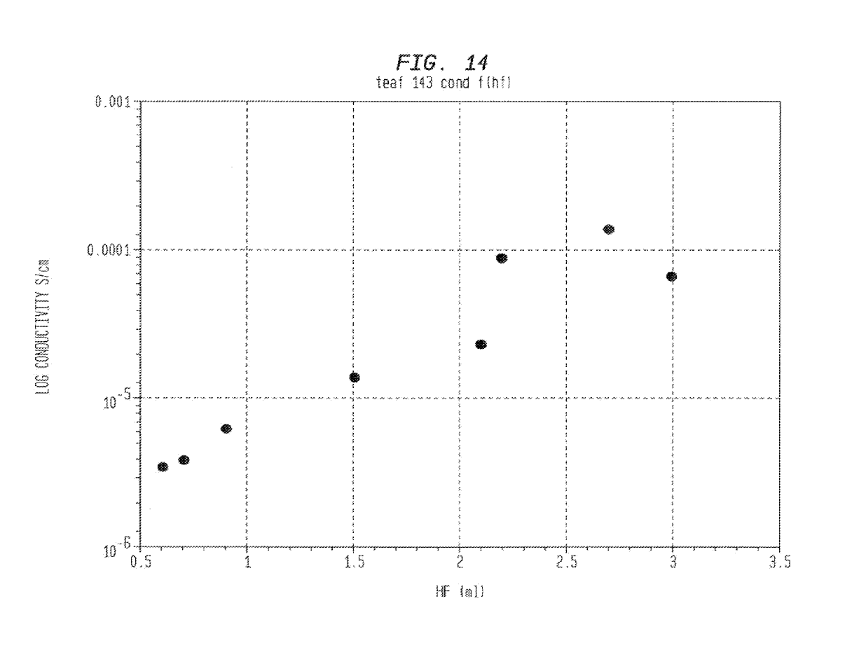

Ionic conductivity of the series of samples was measured. FIG. 14 shows a plot of log conductivity (S/cm) versus HF (ml). A very large systematic trend in increasing conductivity is shown with increasing initial HF content such that an increase of over 2 orders of magnitude to the 10⁻⁴ S/cm range was measured. No free HF is present in these materials; it is entrapped n(HF)F⁻ ion.

### Example 4.2

### Tetraethylammonium Fluoride and Tetramethylammonium Fluoride Electrolytes

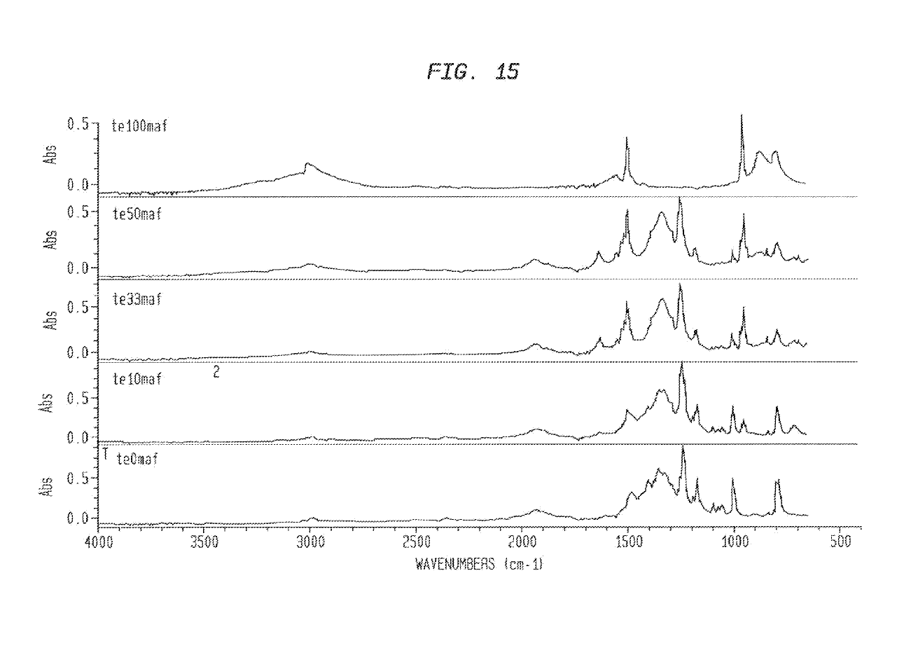

Differing percentages of tetraethylammonium fluoride hydrate and tetramethylammonium fluoride hydrate were intimately mixed and reacted during the drying process at 143° C. under vacuum as described in Example 1. FIG. 15 shows FTIR spectra of the crystalline materials produced by differing ratios of hydrated tetraethylammonium and tetramethylammonium fluoride. All samples, with the exception of pure tetramethyl ammonium (te100maf), displayed a significant broad band at 1450 cm⁻¹ signifying the presence of difluoride anion.

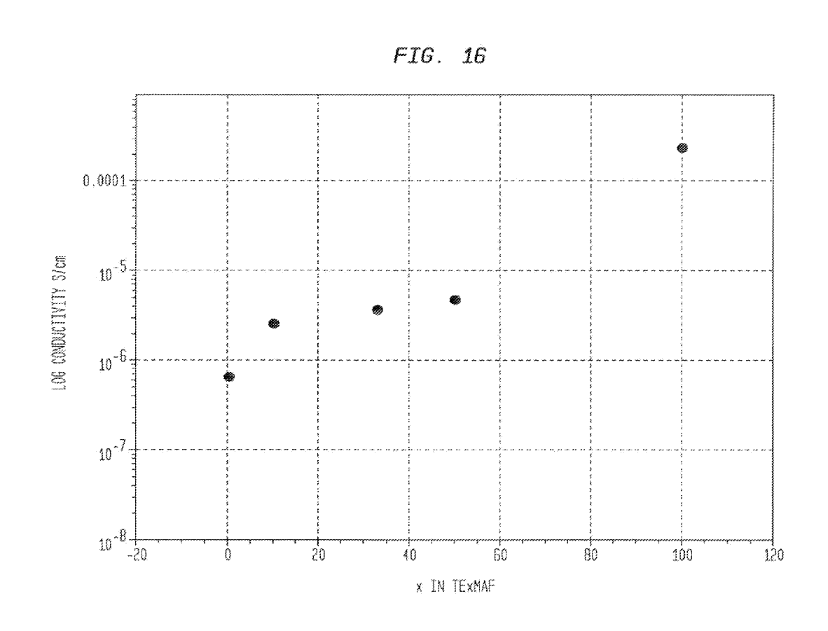

FIG. 16 shows a plot of log conductivity (S/cm) versus x in TExMAF (temaf electrolyte samples fabricated with differing ratios of hydrated tetraethylammonium fluoride and tetramethylammonium fluoride). Samples TE10MAF through TE50MAF exhibited high conductivity of approximately 4-5×10⁻⁶ S/cm. Te0maf exhibited an expected conductivity of about 1×10⁻⁶ S/cm and te100maf revealed a high conductivity of about 2×10⁴ S/cm.

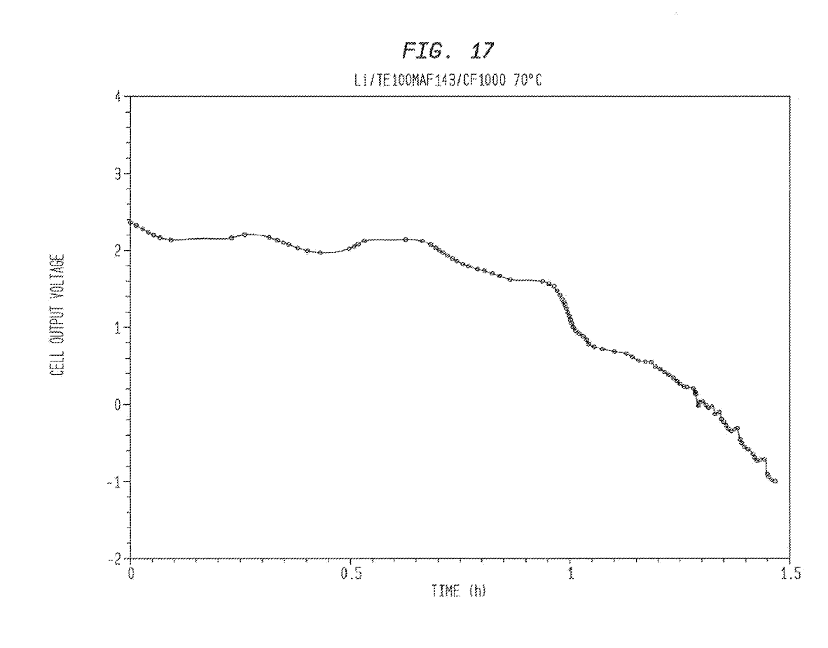

The electrochemical properties of the high conductivity te100maf sample in the absence of the hydrogen bifluoride anion were further investigated. FIG. 17 shows a plot of cell output voltage versus time (hours) of a Li/TE100MAFAF143/CF1000 electrochemical battery cell (non-bifluoride containing TE100MAF electrolyte). The initial voltage was low and extremely poor electrochemical utilization ensued.

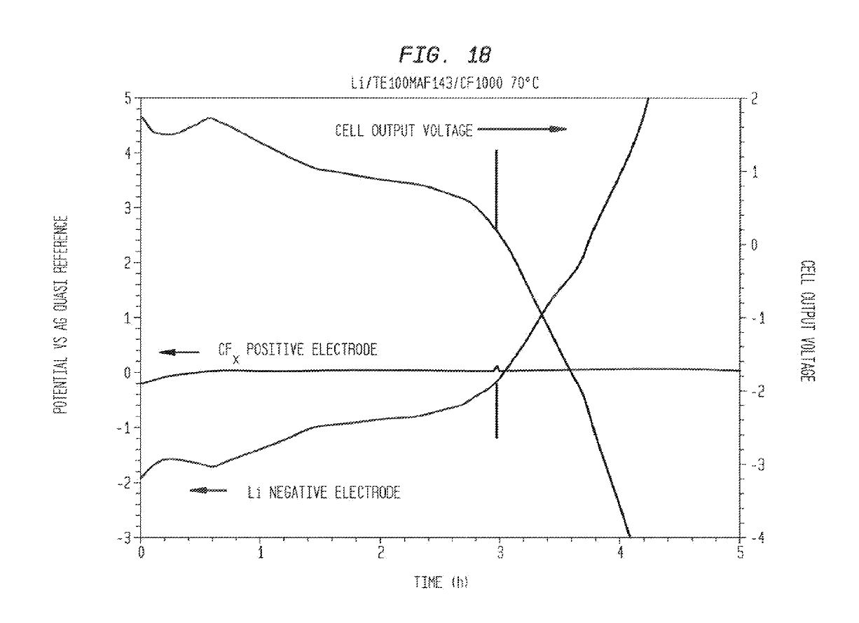

A second cell using the three electrode technique was fabricated to investigate the effect on each electrode. FIG. 18 shows a plot of voltages recorded from the fabricated three electrode Li/TE100MAF/CF_{1.1} electrochemical battery cell and the individual potentials of the Li negative electrode versus the silver quasi reference, CFₓ positive electrode versus the silver quasi reference, and the cell output voltage. As in the case of the teaf electrolyte, the CFₓ positive electrode exhibited a very stable discharge profile. The decrease in the 2 electrode voltage shown in FIGS. 17 and 18 was due to the rapid rise of the voltage of the lithium electrode. The results indicate that, in the case of lithium, the proper identification of the cation associated with the (HFₙ)F⁻ based electrolyte is important to optimize the interfacial stability of the negative electrode with the electrolyte.

### Example 5

### Fabrication of Chargeable Electrochemical Battery Cells

Thin films were utilized to fabricate the electrochemical battery cells. All films were deposited by thermal evaporation. In most examples, 50 nm Titanium was deposited on a borosilicate glass slide. On top of that, a layer of approximately 500 nm of LaF₃ was deposited. A tetraethyl ammonium bifluoride (teaf) separator then was placed on top of the LaF₃ layer. The various positive electrodes are described below:

### Example 5.1

### Silver (Ag) Positive Electrode

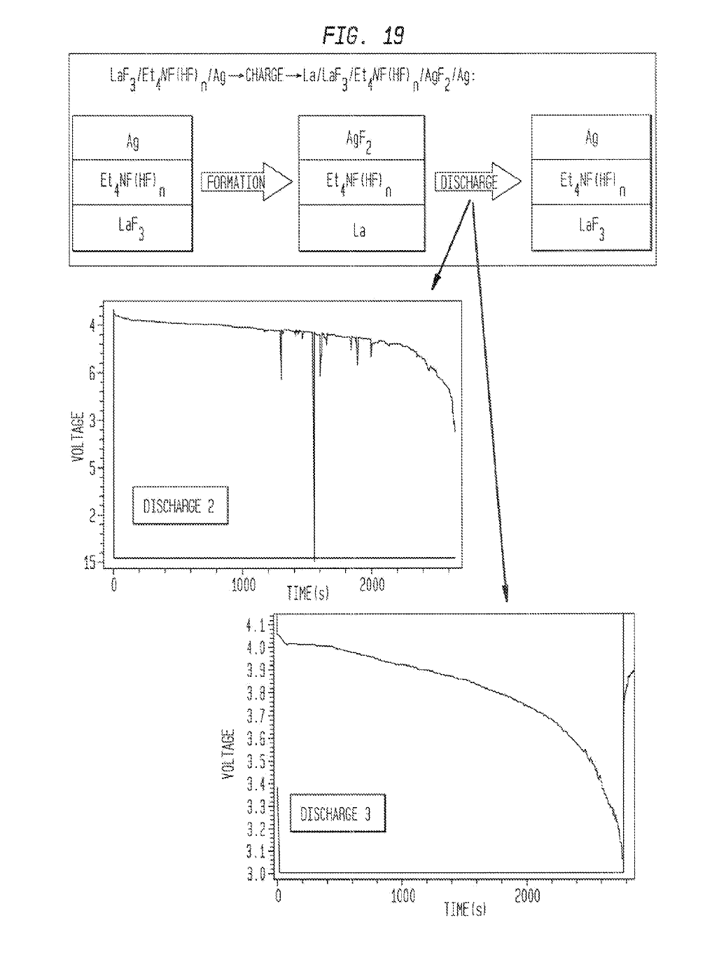

A 300 nm positive electrode of silver (Ag) was utilized as the positive electrode. The electrode was placed in direct contact with the tacky teaf electrolyte. A low open circuit voltage of 1.5V was recorded showing that the cell was in its discharged state. The cell was charged at consecutive constant voltage segments of 10V. After such periods of time, the discharge was at currents ranging from 25 to 200 nA. FIG. 19A shows an illustrative schematic of the electrochemical reaction within the fabricated electrochemical battery cell; FIG. 19B shows a plot of voltage versus time (seconds). The plot shows that a voltage of 4.1 V developed, consistent with the theoretical voltage of an La/AgF₂ couple. This is electrochemical proof that during charge, the negative electrode evolved from LaF₃→La and the positive electrode evolved from Ag→AgF₂, since there is no other conceivable manner in which such voltages can be developed.

### Example 5.2

### Gold (Au) Positive Electrode

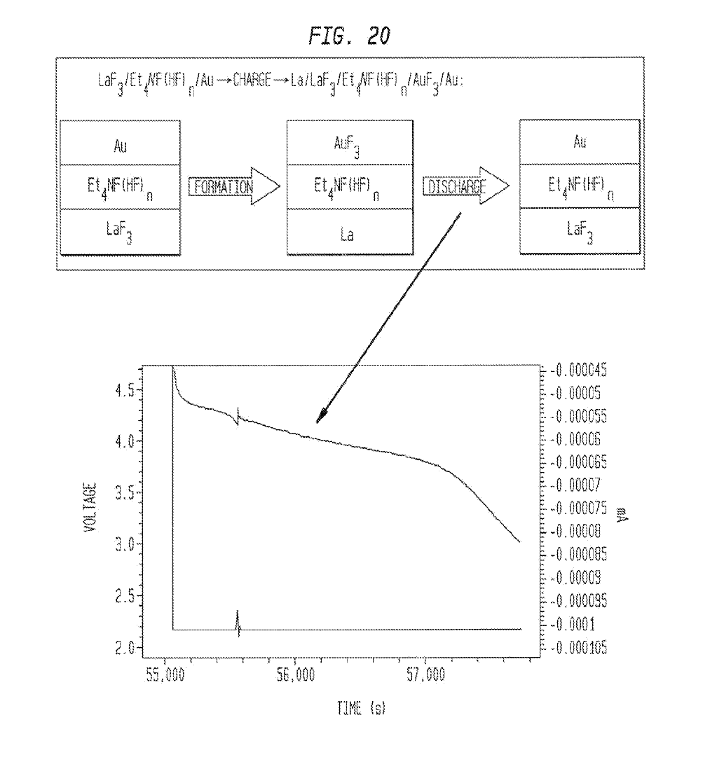

A 300 nm positive electrode of gold (Au) was utilized as the positive electrode. The electrode was placed in direct contact with the tacky teaf electrolyte. A low open circuit voltage of 0.8V was recorded, showing that the cell was in its discharged state. The cell was charged at consecutive constant voltage segments of 10V. After such periods of time, the discharge was at currents ranging from 25 to 200 nA. FIG. 20A shows an illustrative schematic of the electrochemical reaction within the fabricated electrochemical battery cell; FIG. 20B shows a plot of voltage versus time (seconds). The plot shows that a voltage of 4.6V developed, consistent with the theoretical voltage of a La/AuF₃ couple. This is electrochemical proof that during charge, the negative electrode evolved from LaF₃→La and the positive electrode evolved from Au→AuF₃, as there is no other conceivable manner in which such voltages can be developed. In addition, the voltage was different from that achieved with the Ag electrode, showing that the redox of the metal is involved.

### Example 5.3

### Graphite Composite Positive Electrode

A composite electrode of multiwalled carbon nanotube and PvDF binder was fabricated. The electrode was compressed and placed in contact with the teaf electrolyte. A low open circuit voltage of 0.8V was recorded, showing that the cell was in its discharged state. The cell was charged at consecutive constant voltage segments of 10V. After such periods of time, the discharge was at currents ranging from 25 to 200 nA.

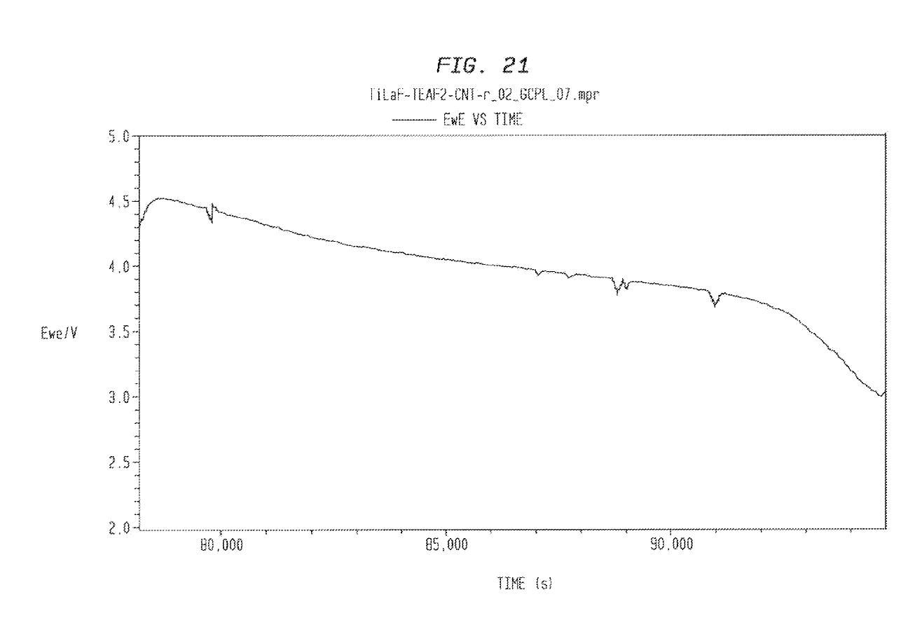

FIG. 21 shows a plot of voltage versus time (seconds). The plot shows that a voltage of 4.5V developed, consistent with the theoretical voltage of a La/CFₓ couple. This is electrochemical proof that during charge the negative electrode evolved from LaF₃→La and the positive electrode evolved from C→CFₓ or CHF_{X}, as there is no other conceivable manner in which such voltages can be developed. In addition the voltage was different from that achieved with the Ag or Au electrode showing the redox of the graphite is involved.

While the present invention has been described with reference to the specific embodiments thereof, it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present invention. All such modifications are intended to be within the scope of the claims appended hereto.

What is claimed is:

1. An electrolyte for an electrochemical battery cell, the electrolyte comprising at least one bifluoride anion.

2. The electrolyte according to claim 1, wherein the bifluoride anion is of the formula (F(HF)ₙ⁻), where n is from >0 to 10.

3. The electrolyte according to claim 1, wherein the bifluoride anion is of the formula ((F(HF)ₙ⁻), wherein n=1.

4. The electrolyte according to claim 1, wherein the bifluoride anion is of the formula ((F(HF)ₙ⁻), wherein n=2.

5. The electrolyte according to claim 1, wherein the bifluoride anion is of the formula (F(HF)ₙ⁻), wherein n=3.

6. The electrolyte according to claim 1, wherein the electrolyte comprises a plurality of bifluoride anions.

7. The electrolyte according to claim 1, wherein the electrolyte comprises at least one cation comprising at least one organic group.

8. The electrolyte according to claim 7, wherein the at least one cation comprising at least one organic compound is a tetraalkyl ammonium, and wherein the alkyl is an alkyl of 1 to 10 carbon atoms.

9. The electrolyte according to claim 7, wherein the electrolyte is a tetralkylammonium (HF)ₙF⁻ wherein n is from >0 to 10.

10. The electrolyte according to claim 7, wherein the electrolyte is tetraethyl ammonium (HF)ₙF⁻ wherein n is from >0 to 10.

11. The electrolyte according to claim 7, wherein the electrolyte is tetrapropyl ammonium (HF)ₙF⁻ where n is from >0 to 10.

12. The electrolyte according to claim 7, wherein the electrolyte is tetramethyl ammonium (HF)ₙF⁻ where n is from >0 to 10.

13. The electrolyte according to claim 1, wherein the electrolyte comprises a plurality of (HF)ₙF⁻ containing salts, wherein n is from >0 to 10.

14. The electrolyte according to claim 7, wherein the electrolyte comprises pyridinium (HF)ₙF⁻ where n is from >0 to 10.

15. The electrolyte according to claim 7, wherein the electrolyte comprises tetramethyl ammonium (HF)ₙF⁻ where n is from >0 to 10.

16. The electrolyte according to claim 7, wherein the electrolyte comprises potassium (HF)ₙF⁻ where n is from >0 to 10.

17. The electrolyte according to claim 7, wherein the electrolyte comprises calcium (HF)ₙF⁻ where n is from >0 to 10.

18. The electrolyte according to claim 7, wherein the electrolyte comprises an ionic liquid comprising (HF)ₙF⁻ where n is from >0 to 10.

19. The electrolyte according to claim 7, wherein the electrolyte comprises an onium (HF)ₙF⁻ where n is from >0 to 10.

20. The electrolyte according to claim 1, wherein the electrolyte further comprises 1,3-dialkylimidazolium fluorogydrogenate (HF)ₙF⁻ where n is from >0 to 10.

21. The electrolyte according to claim 1, wherein the electrolyte is a catholyte.

22. A fluoride anion conducting material comprising (i) a positive electrode; (ii) a negative electrode; and (iii) an electrolyte comprising a fluoride anion of the formula (HF)ₙF⁻ wherein n is >0 to 10; whereby the material conducts F− anions.

23. The fluoride anion conducting material according to claim 22, wherein the positive electrode comprises at least one metal or at least one carbon, wherein the at least one metal or at least one carbon is in an electrochemically reduced state; and the negative electrode comprises at least one metal fluoride.

24. The fluoride anion conducting material according to claim 23, wherein the positive electrode comprises at least one carbon selected from the group consisting of graphite, a single walled carbon nanotube, and a multiwalled carbon nanotube.

25. The fluoride anion conducting material according to claim 23, wherein the positive electrode comprises at least one metal selected from the group consisting of Bi, Cu, Mo, Fe, Ag, Au, Pd, Ni, Co, Mn and V.

26. The fluoride anion conducting material according to claim 23, wherein the negative electrode comprises an alkali fluoride.

27. The fluoride anion conducting material according to claim 23, wherein the negative electrode comprises an alkaline earth fluoride.

28. The fluoride anion conducting material according to claim 23, wherein the negative electrode comprises an element selected from the group consisting of Zn, Al, Si, and Ge.

29. The fluoride anion conducting material according to claim 22, wherein the positive electrode comprises at least one metal fluoride or at least one carbon fluoride, wherein the at least one metal fluoride or at least one carbon fluoride is in an electrochemically oxidized state; and the negative electrode comprises at least one metal.

30. The fluoride anion conducting material according to claim 29, wherein the positive electrode comprises a graphite fluoride.

31. The fluoride anion conducting material according to claim 29, wherein the positive electrode comprises at least one compound selected from the group consisting of bismuth fluoride, silver fluoride, nickel fluoride, copper fluoride, lead fluoride, cobalt fluoride, molybdenum fluoride and iron fluoride.

32. The fluoride anion conducting material according to claim 29, wherein the positive electrode further comprises at least one electronically conductive material.

33. The fluoride anion conducting material according to claim 22, wherein the positive electrode is an electrode where a predominant diffusing species is a fluoride ion.

34. The fluoride anion conducting material according to claim 22, wherein the positive electrode comprises a nanostructure carbon selected from the group consisting of a nanographite, a carbon nanotube, a buckyball, a mesoporous carbon, and a microporous carbon.

35. The fluoride anion conducting material according to claim 22, wherein the negative electrode accepts a fluoride ion.

36. The fluoride anion conducting material according to claim 22, wherein the negative electrode comprises lanthanum.

37. The fluoride anion conducting material according to claim 22, wherein the negative electrode comprises lithium.

38. The fluoride anion conducting material according to claim 22, wherein the negative electrode comprises sodium.

39. The fluoride anion conducting material according to claim 22, wherein the negative electrode comprises calcium.

40. The fluoride anion conducting material according to claim 22, wherein the negative electrode comprises strontium.

41. The fluoride anion conducting material according to claim 22, wherein the negative electrode comprises barium.

42. The fluoride anion conducting material according to claim 22, wherein the negative electrode comprises rubidium.

43. The fluoride anion conducting material according to claim 22, wherein the negative electrode comprises potassium.

44. The fluoride anion conducting material according to claim 22, wherein the electrolyte comprises at least one bifluoride anion.

45. The fluoride anion conducting material according to claim 22, wherein the at least one bifluoride anion is of the formula (F(HF)ₙ⁻), wherein n is from >0 to 10.

46. The fluoride anion conducting material according to claim 22, wherein the at least one bifluoride anion is of the formula (F(HF)ₙ⁻), wherein n=1.

47. The fluoride anion conducting material according to claim 22, wherein the at least one bifluoride anion is of the formula (F(HF)ₙ⁻), wherein n=2.

48. The fluoride anion conducting material according to claim 22, wherein the at least one bifluoride anion is of the formula (F(HF)ₙ⁻), wherein n=3.

49. The fluoride anion conducting material according to claim 22, wherein the electrolyte comprises a plurality of bifluoride anions.

50. The fluoride anion conducting material according to claim 22, wherein the electrolyte comprises at least one cation comprising at least one organic group.

51. The fluoride anion conducting material according to claim 22, wherein the at least one cation comprising at least one organic group is a tetralkylammonium bifluoride, wherein the alkyl is an alkyl from 1 to 10 carbons.

52. The fluoride anion conducting material according to claim 22, wherein the electrolyte is a tetraalkyl ammonium (HF)ₙF⁻, wherein n is from >0 to 10, and wherein the alkyl is an alkyl of 1 to 10 carbon atoms.

53. The fluoride anion conducting material according to claim 22, wherein the electrolyte is tetraethyl ammonium (HF)ₙF⁻ wherein n is from >0 to 10.

54. The fluoride anion conducting material according to claim 22, wherein electrolyte is tetrapropyl ammonium (HF)ₙF⁻ wherein n is from >0 to 10.

55. The fluoride anion conducting material according to claim 22, wherein the electrolyte is tetramethyl ammonium (HF)ₙF⁻ wherein n is from >0 to 10.

56. The fluoride anion conducting material according to claim 22, wherein the electrolyte comprises a plurality of (HF)ₙF⁻ containing organic groups, wherein n is from >0 to 10.

57. The fluoride anion conducting material according to claim 22, wherein the electrolyte further comprises diphenylguanidium (HF)ₙF⁻ wherein n is from >0 to 10.

58. The fluoride anion conducting material according to claim 22, wherein the electrolyte further comprises 1,3-dialkylimidazolium fluorogydrogenate (HF)ₙF⁻ wherein n is from >0 to 10.

59. The fluoride anion conducting material according to claim 1, wherein the electrolyte is substantially free of HF.

60. A rechargeable electrochemical battery cell comprising:
(i) a negative electrode comprising a metal fluoride;
(ii) an electrolyte comprising (HF)ₙF− where n is from >0 to 10;
(iii) an optional additional electrolyte; and
(iv) a positive electrode comprising a compound of a low oxidation state,
wherein a predominant diffusing species is a fluoride ion

61. The rechargeable electrochemical battery cell according to claim 60, wherein the negative electrode comprises at least one element selected from the group consisting of lanthanum, lithium, sodium, calcium, strontium, barium, potassium, and rubidium.

62. The rechargeable electrochemical battery cell according to claim 60, wherein the positive electrode comprises an element selected from the group consisting of carbon, silver, gold, copper, bismuth, nickel, cobalt, molyndenum, manganese, vanadium and palladium.

63. The rechargeable electrochemical battery cell according to claim 60, wherein the positive electrode comprises at least one nanostructured carbon selected from the group consisting of a nanographite, a carbon nanotube, a buckyball, a mesoporous carbon and a microporous carbon.

64. The rechargeable electrochemical battery cell according to claim 60, wherein the positive electrode is a partially oxidized positive electrode.

65. The rechargeable electrochemical battery cell according to claim 64, wherein the partially oxidized positive electrode comprises at least one compound selected from the group consisting of BiF₃, bismuth oxyfluoride, CuF₂, MnF₂, NiF₂, CoF₂, CFₓ where x<1, AgF, a first row transition metal oxide, and a silver oxide.

66. The rechargeable electrochemical battery cell according to claim 60, wherein the electrolyte is a solid state fluoride conductor.

67. The rechargeable electrochemical battery cell according to claim 60, wherein the electrolyte comprises at least one bifluoride anion.

68. The rechargeable electrochemical battery cell according to claim 67, wherein the at least one bifluoride anion is of the formula (F(HF)ₙ⁻), wherein n is from >0 to 10.

69. The rechargeable electrochemical battery cell according to claim 67, wherein the at least one bifluoride anion is of the formula (F(HF)ₙ⁻), wherein n=1.

70. The rechargeable electrochemical battery cell according to claim 67, wherein the at least one bifluoride anion is of the formula (F(HF)ₙ⁻), wherein n=2.

71. The rechargeable electrochemical battery cell according to claim 67, wherein the at least one bifluoride anion is of the formula (F(HF)ₙ⁻), wherein n=3.

72. The rechargeable electrochemical battery cell according to claim 60, wherein the electrolyte comprises a plurality of bifluoride anions.

73. The rechargeable electrochemical battery cell according to claim 60, wherein the electrolyte comprises at least cation comprising at least one organic group.

74. The rechargeable electrochemical battery cell according to claim 73, wherein the at least one cation comprising at least one organic group is a tetralkylammonium bifluoride, wherein the alkyl is an alkyl from 1 to 10 carbons.

75. The rechargeable electrochemical battery cell according to claim 74, wherein the electrolyte is a tetraalkylammonium (HF)ₙF⁻ wherein n is from >0 to 10, and wherein the alkyl is an alkyl of 1 to 10 carbon atoms.

76. The rechargeable electrochemical battery cell according to claim 73, wherein the electrolyte is tetraethyl ammonium (HF)ₙF⁻ wherein n is from >0 to 10.

77. The rechargeable electrochemical battery cell according to claim 73, wherein the electrolyte is tetrapropyl ammonium (HF)ₙF⁻ wherein n is from >0 to 10.

78. The rechargeable electrochemical battery cell according to claim 73, wherein the electrolyte is tetramethyl ammonium (HF)ₙF⁻ wherein n is from >0 to 10.

79. The rechargeable electrochemical battery cell according to claim 60, wherein the electrolyte comprises a plurality of (HF)ₙF⁻ containing organic groups, wherein n is from >0 to 10.

80. The rechargeable electrochemical battery cell according to claim 60, wherein the electrolyte further comprises diphenylguanidium (HF)ₙF⁻ wherein n is from >0 to 10.

81. The rechargeable electrochemical battery cell according to claim 60, wherein the electrolyte further comprises 1,3-dialkylimidazolium fluorogydrogenate (HF)ₙF⁻ wherein n is from >0 to 10.

82. The rechargeable electrochemical battery cell according to claim 60, wherein the electrolyte is substantially free of HF.

83. The rechargeable electrochemical battery cell according to claim 60, wherein the electrochemical battery cell operates at a voltage greater than or equal to 4V.
